(19) United States
(12) Patent Application Publication
(10) Pub. No.: US 2024/0430747 A1
(43) Pub. Date: Dec. 26, 2024

(54) UU ADAPTATION LAYER SUPPORT FOR LAYER TWO RELAYING

(71) Applicant: QUALCOMM Incorporated, San Diego, CA (US)

(72) Inventors: Karthika PALADUGU, Hyderabad (IN); Hong CHENG, Basking Ridge, NJ (US); Shankar KRISHNAN, Poway, CA (US); Xipeng ZHU, San Diego, CA (US); Gavin Bernard HORN, La Jolla, CA (US); Peng CHENG, Beijing (CN)

(21) Appl. No.: 18/707,058

(22) PCT Filed: Jan. 5, 2022
(86) PCT No.: PCT/CN2022/070266

§ 371 Date: May 2, 2024

(51) Int. Cl. H04W 28/08; H04W 40/22; H04W 72/40

(52) U.S. Cl. CPC H04W 28/0875; H04W 40/22; H04W 72/40

(57) ABSTRACT

Methods, systems, and devices for wireless communication are described. A central unit (CU) of a network entity may receive, from a first user equipment (UE) via a second UE, a connection setup request message for a first UE. The CU may establish UE context information for the first UE at an adaptation layer of the CU, the CE context information based at least in part on communications between the first UE and the network entity via the second UE. The CU may transmit, to a distributed unit (DU) associated with the CU, an indication of a relaying configuration for the first UE connecting to the network entity via the second UE, the relaying configuration comprising multiplexing and forwarding information for a connection between the second UE the DU. The CU may communicate with the first UE via the second UE according to the UE context information and the relaying configuration.

### CROSS REFERENCE

The present Application is a 371 national phase filing of International PCT Application No. PCT/CN2022/070266 by PALADUGU et al., entitled “UU ADAPTATION LAYER SUPPORT FOR LAYER TWO RELAYING,” filed Jan. 5, 2022, which is assigned to the assignee hereof, and which is expressly incorporated by reference in its entirety herein.

### FIELD OF TECHNOLOGY

The following relates to wireless communication, including Uu adaptation layer support for layer two relaying.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support Uu adaptation layer support for layer two relaying. Generally, aspects of the techniques described herein generally provide proposals for implementation of an adaptation layer (AL) at a base station (e.g., a network entity, such as an entity within a next generation radio access network (NG RAN)). One option includes the AL being implemented at a central unit (CU) function of the base station. For example, the CU (e.g., the control plane of the CU) may receive a connection setup message for a remote user equipment (UE) (e.g., a first UE in this example). The CU (e.g., the AL implemented at the CU) may generally establish context information for the remote UE supporting the relayed communications between the remote UE and the base station via a relay UE (e.g., a second UE in this example). This may include establishing a relaying configuration for the remote UE identifying multiplexing and forwarding information for the connection between the relay UE and a distributed unit (DU) of the base station, e.g., a DU associated with the CU of the base station. The CU may transmit an indication of the relaying configuration to the DU, but without including the UE context information of the remote UE. Accordingly, the DU in this option may not be aware of the remote UE. Instead, the AL at the CU may manage aspects of establishing UE context information for the remote UE, such as establishing a local remote UE identifier (ID), establishing bearer(s) for the remote UE, establishing/managing mappings between the remote UE bearers and a sidelink connection (or Wi-Fi connection, Bluetooth connection, etc.) between the remote UE and the relay UE, mappings between the sidelink (or other) connections to the Uu connection (e.g., radio link control (RLC) channels) between the relay UE and the DU, and the like. Accordingly, the base station may communicate with the remote UE via the relay UE according to the UE context information and the relaying configuration. Thus, the DU in this example may route remote UE traffic according to the relaying configuration, without an understanding that the traffic being relayed is from a specific remote UE.

Another option (e.g., a second option) may include the AL being implemented at the DU of the base station. In this option, the DU may be configured with the remote UE context information (e.g., is aware that the remote UE, the second UE in this example, is connected via the relay UE, the first UE in this example). The CU (e.g., in its own AL implementation, in some examples) may manage aspects of the techniques described in the first option, but may inform the DU of the context information for the remote UE. Accordingly, the AL implemented at the DU may provide Uu AL support for control and user plane data between the CU and the remote/relay UE, such as AL header support for downlink traffic, routing of uplink AL protocol data unit (PDU) to the remote UE CU user plane, etc.

A method for wireless communication at a CU of a network entity is described. The method may include receiving, from a first UE via a second UE, a connection setup request message for a first UE, establishing UE context information for the first UE at an adaptation layer of the CU, the UE context information based on communications between the first UE and the network entity via the second UE, transmitting, to one or more DUs associated with the CU, an indication of a relaying configuration for the first UE connecting to the network entity via the second UE, the relaying configuration including multiplexing and forwarding information for a connection between the second UE and each DU of the one or more DUs, and communicating with the first UE via the second UE according to the UE context information and the relaying configuration.

An apparatus for wireless communication at a CU of a network entity is described. The apparatus may include a processor, memory coupled with the processor, and instructions stored in the memory. The instructions may be executable by the processor to cause the apparatus to receive, from a first UE via a second UE, a connection setup request message for a first UE, establish UE context information for the first UE at an adaptation layer of the CU, the UE context information based on communications between the first UE and the network entity via the second UE, transmit, to one or more DUs associated with the CU, an indication of a relaying configuration for the first UE connecting to the network entity via the second UE, the relaying configuration including multiplexing and forwarding information for a connection between the second UE and each DU of the one or more DUs, and communicate with the first UE via the second UE according to the UE context information and the relaying configuration.

Another apparatus for wireless communication at a CU of a network entity is described. The apparatus may include means for receiving, from a first UE via a second UE, a connection setup request message for a first UE, means for establishing UE context information for the first UE at an adaptation layer of the CU, the UE context information based on communications between the first UE and the network entity via the second UE, means for transmitting, to one or more DUs associated with the CU, an indication of a relaying configuration for the first UE connecting to the network entity via the second UE, the relaying configuration including multiplexing and forwarding information for a connection between the second UE and each DU of the one or more DUs, and means for communicating with the first UE via the second UE according to the UE context information and the relaying configuration.

A non-transitory computer-readable medium storing code for wireless communication at a CU of a network entity is described. The code may include instructions executable by a processor to receive, from a first UE via a second UE, a connection setup request message for a first UE, establish UE context information for the first UE at an adaptation layer of the CU, the UE context information based on communications between the first UE and the network entity via the second UE, transmit, to one or more DUs associated with the CU, an indication of a relaying configuration for the first UE connecting to the network entity via the second UE, the relaying configuration including multiplexing and forwarding information for a connection between the second UE and each DU of the one or more DUs, and communicate with the first UE via the second UE according to the UE context information and the relaying configuration.

In some examples of the method, apparatuses, and non-transitory computer-readable medium described herein, establishing the UE context information for the first UE may include operations, features, means, or instructions for allocating, at a control plane of the CU, a remote UE identifier to the first UE, establishing association and context information for the first UE and the second UE, the association and context information including an association between the remote UE identifier and the first UE, one or more bearers for the first UE, or both, establishing multiplexing information for the one or more bearers of the first UE, the multiplexing information including a first mapping between the one or more bearers of the first UE to one or more sidelink channels between the first UE and the second UE and a second mapping between the sidelink channel to one or more cellular channels of the second UE, and assigning, based on the multiplexing information, channel identifiers to the one or more sidelink channels and to the one or more cellular channels.

Some examples of the method, apparatuses, and non-transitory computer-readable medium described herein may further include operations, features, means, or instructions for transmitting the indication of the context information to the first UE and to the second UE.

Some examples of the method, apparatuses, and non-transitory computer-readable medium described herein may further include operations, features, means, or instructions for determining an end-to-end quality of service for the one or more bearers of the first UE and establishing a sidelink quality of service parameter for each of the one or more sidelink channels and the one or more cellular channels based on the end-to-end quality of service.

Some examples of the method, apparatuses, and non-transitory computer-readable medium described herein may further include operations, features, means, or instructions for determining a slicing configuration for the one or more bearers of the first UE, where the relaying configuration may be based on the slicing configuration.

Some examples of the method, apparatuses, and non-transitory computer-readable medium described herein may further include operations, features, means, or instructions for determining, at the control plane of the CU, at a user plane of the CU, or both, an adaptation layer PDU mapping for the first UE, the PDU mapping including a PDU-to-packet data convergence protocol (PDCP) mapping of the first UE, a PDU-to-channel mapping for the one or more cellular channels, or both.

Some examples of the method, apparatuses, and non-transitory computer-readable medium described herein may further include operations, features, means, or instructions for transmitting, from a control plane of the CU to a user plane of the CU, an indication of a remote UE identifier for the first UE and transmitting, to the one or more DUs, an indication of one or more relay cellular channels associated with the first UE.

Some examples of the method, apparatuses, and non-transitory computer-readable medium described herein may further include operations, features, means, or instructions for transmitting, from a control plane of the CU to a user plane of the CU, a bearer context message for the first UE indicating uplink user plane tunneling information mapping a radio link control channel between the second UE and the DU to a bearer associated with the first UE, where the mapping may be based on a local remote UE identifier associated with the first UE.

Some examples of the method, apparatuses, and non-transitory computer-readable medium described herein may further include operations, features, means, or instructions for transmitting, from a control plane of the CU to a user plane of the CU, a bearer context message for the first UE indicating downlink user plane tunneling information mapping a radio link control channel between the second UE and the DU to a bearer associated with the first UE.

A method for wireless communication at a DU of a network entity is described. The method may include receiving, from a CU of the network entity, an indication of a relaying configuration for a first UE connecting to the network entity via a second UE, determining, based on the relaying configuration, multiplexing and forwarding information for the connection between the second UE and the DU, and relaying communications between the first UE and the network entity via the second UE according to the multiplexing and forwarding information.

An apparatus for wireless communication at a DU of a network entity is described. The apparatus may include a processor, memory coupled with the processor, and instructions stored in the memory. The instructions may be executable by the processor to cause the apparatus to receive, from a CU of the network entity, an indication of a relaying configuration for a first UE connecting to the network entity via a second UE, determine, based on the relaying configuration, multiplexing and forwarding information for the connection between the second UE and the DU, and relay communications between the first UE and the network entity via the second UE according to the multiplexing and forwarding information.

Another apparatus for wireless communication at a DU of a network entity is described. The apparatus may include means for receiving, from a CU of the network entity, an indication of a relaying configuration for a first UE connecting to the network entity via a second UE, means for determining, based on the relaying configuration, multiplexing and forwarding information for the connection between the second UE and the DU, and means for relaying communications between the first UE and the network entity via the second UE according to the multiplexing and forwarding information.

A non-transitory computer-readable medium storing code for wireless communication at a DU of a network entity is described. The code may include instructions executable by a processor to receive, from a CU of the network entity, an indication of a relaying configuration for a first UE connecting to the network entity via a second UE, determine, based on the relaying configuration, multiplexing and forwarding information for the connection between the second UE and the DU, and relay communications between the first UE and the network entity via the second UE according to the multiplexing and forwarding information.

Some examples of the method, apparatuses, and non-transitory computer-readable medium described herein may further include operations, features, means, or instructions for receiving, from the CU of the network entity, an indication of a relay channel configuration associated with the first UE and establishing one or more relay cellular channels with the second UE based on the relay channel configuration.

A method for wireless communication at a DU of a network entity is described. The method may include obtaining, from a CU of the network entity, a context setup request message for a first UE, establishing UE context information for the first UE at the CU, the UE context information based on communications between a second UE and the network entity via the first UE, establishing, at an adaptation layer of the DU, a relaying configuration for the second UE connecting to the network entity via the first UE, the relaying configuration including multiplexing and forwarding information for a connection between the first UE and the DU, and communicating with the second UE via the first UE according to the UE context information and the relaying configuration.

An apparatus for wireless communication at a DU of a network entity is described. The apparatus may include a processor, memory coupled with the processor, and instructions stored in the memory. The instructions may be executable by the processor to cause the apparatus to obtain, from a CU of the network entity, a context setup request message for a first UE, establish UE context information for the first UE at the CU, the UE context information based on communications between a second UE and the network entity via the first UE, establish, at an adaptation layer of the DU, a relaying configuration for the second UE connecting to the network entity via the first UE, the relaying configuration including multiplexing and forwarding information for a connection between the first UE and the DU, and communicate with the second UE via the first UE according to the UE context information and the relaying configuration.

Another apparatus for wireless communication at a DU of a network entity is described. The apparatus may include means for obtaining, from a CU of the network entity, a context setup request message for a first UE, means for establishing UE context information for the first UE at the CU, the UE context information based on communications between a second UE and the network entity via the first UE, means for establishing, at an adaptation layer of the DU, a relaying configuration for the second UE connecting to the network entity via the first UE, the relaying configuration including multiplexing and forwarding information for a connection between the first UE and the DU, and means for communicating with the second UE via the first UE according to the UE context information and the relaying configuration.

A non-transitory computer-readable medium storing code for wireless communication at a DU of a network entity is described. The code may include instructions executable by a processor to obtain, from a CU of the network entity, a context setup request message for a first UE, establish UE context information for the first UE at the CU, the UE context information based on communications between a second UE and the network entity via the first UE, establish, at an adaptation layer of the DU, a relaying configuration for the second UE connecting to the network entity via the first UE, the relaying configuration including multiplexing and forwarding information for a connection between the first UE and the DU, and communicate with the second UE via the first UE according to the UE context information and the relaying configuration.

Some examples of the method, apparatuses, and non-transitory computer-readable medium described herein may further include operations, features, means, or instructions for receiving, from the CU, a UE context setup request message indicating remote UE bearer information associated with the second UE, the remote UE bearer information including a remote UE identifier, one or more bearer identifiers, mapping of a radio link control channel between the first UE and the DU, uplink user plane tunneling information, or any combination thereof for the second UE.

Some examples of the method, apparatuses, and non-transitory computer-readable medium described herein may further include operations, features, means, or instructions for transmitting, to the CU, a UE context setup response message indicating a result of establishing remote UE bearers associated with the first UE, the UE context setup response message including at least one of a remote UE identifier, one or more bearer identifiers, downlink user plane tunneling information, or any combination thereof for the first UE.

Some examples of the method, apparatuses, and non-transitory computer-readable medium described herein may further include operations, features, means, or instructions for establishing association and context information for the first UE and the second UE, the association and context information including an association between a remote UE identifier and the first UE, one or more bearers for the first UE, or both, establishing multiplexing information for the one or more bearers of the first UE, the multiplexing information including a first mapping between the one or more bearers of the first UE to one or more sidelink channels between the first UE and the second UE and a second mapping between the sidelink channel to one or more cellular channels of the second UE, and assigning, based on the multiplexing information, channel identifiers to the one or more sidelink channels and to the one or more cellular channels.

Some examples of the method, apparatuses, and non-transitory computer-readable medium described herein may further include operations, features, means, or instructions for receiving, from a control plane of the CU, an indication of downlink traffic for the first UE, the indication including a remote UE identifier associated with the first UE, a remote UE bearer identifier, a relay cellular channel identifier, or any combination thereof and transmitting the downlink traffic to the first UE for forwarding to the second UE according to the indication.

Some examples of the method, apparatuses, and non-transitory computer-readable medium described herein may further include operations, features, means, or instructions for receiving, from the first UE, an indication of uplink traffic from the second UE, the indication including a remote UE identifier associated with the first UE, a remote UE bearer identifier, a relay cellular channel identifier, or any combination thereof and transmitting the uplink traffic to a control plane of the UE for forwarding to a destination address associated with the uplink traffic.

Some examples of the method, apparatuses, and non-transitory computer-readable medium described herein may further include operations, features, means, or instructions for signaling radio bearers (SRBs) and data radio bearers (DRBs) may be managed at the DU of the network entity or the SRBs may be managed at the CU of the network entity with the DRBs being managed at the DU of the network entity.

### BRIEF DESCRIPTION OF THE DRAWINGS

FIG. 1 illustrates an example of a wireless communications system that supports Uu adaptation layer support for layer two relaying in accordance with aspects of the present disclosure.

FIG. 2 illustrates an example of a wireless communication system that supports Uu adaptation layer support for layer two relaying in accordance with aspects of the present disclosure.

FIG. 3 illustrates an example of a protocol stack that supports Uu adaptation layer support for layer two relaying in accordance with aspects of the present disclosure.

FIG. 4 illustrates an example of a process that supports Uu adaptation layer support for layer two relaying in accordance with aspects of the present disclosure.

FIG. 5 illustrates an example of a process that supports Uu adaptation layer support for layer two relaying in accordance with aspects of the present disclosure.

FIG. 6 illustrates an example of a wireless communication system that supports Uu adaptation layer support for layer two relaying in accordance with aspects of the present disclosure.

FIG. 7 illustrates an example of a wireless communication system that supports Uu adaptation layer support for layer two relaying in accordance with aspects of the present disclosure.

FIG. 8A illustrates an example of a control plane protocol stack that supports Uu adaptation layer support for layer two relaying in accordance with aspects of the present disclosure.

FIG. 8B illustrates an example of a user plane protocol stack that supports Uu adaptation layer support for layer two relaying in accordance with aspects of the present disclosure.

FIG. 9 illustrates an example of a process that supports Uu adaptation layer support for layer two relaying in accordance with aspects of the present disclosure.

FIG. 10 illustrates an example of a process that supports Uu adaptation layer support for layer two relaying in accordance with aspects of the present disclosure.

FIGS. 11 and 12 show block diagrams of devices that support Uu adaptation layer support for layer two relaying in accordance with aspects of the present disclosure.

FIG. 13 shows a block diagram of a communications manager that supports Uu adaptation layer support for layer two relaying in accordance with aspects of the present disclosure.

FIG. 14 shows a diagram of a system including a device that supports Uu adaptation layer support for layer two relaying in accordance with aspects of the present disclosure.

FIGS. 15 through 19 show flowcharts illustrating methods that support Uu adaptation layer support for layer two relaying in accordance with aspects of the present disclosure.

### DETAILED DESCRIPTION

Some wireless communication systems support a base station including a Uu interface adaptation layer (AL) to manage aspects of wireless communications between the base station and one or more user equipment (UE). In some examples, this may include the AL managing one or more aspects of layer two (L2) relaying operations between a relay UE and one or more remote UE(s). This may include end-to-end bearers (e.g., signaling radio bearer(s) (SRB) (s) and/or data radio bearer(s) (DRB) (s)) of the remote UE being N:1 mapped and data multiplexed over one (or more) Uu radio link control (RLC) channel(s) of the relay UE. For example, a base station (e.g., a network entity, such as an entity within a next generation radio access network (NG RAN)) may configure the relay UE with Uu RLC channel(s) for the remote UE bearers during connection setup/resume/reestablishment procedures. However, such wireless communication systems may also support a central unit (CU)/distributed unit (DU) functional split at the base station. For example, the CU may manage aspects of higher layer functionality (e.g., packet data convergence protocol (PDCP), internet protocol (IP), non-access stratum (NAS), and the like) while the DU manages aspects of lower layer functionality (e.g., physical layer (PHY), medium access control (MAC) layer, RLC layer, and the like) at the base station. However, such wireless networks do not define where the AL is configured within the CU/DU split, which may result in L2 relaying configuration synchronization issues between the different functions/layers of the connection.

Generally, aspects of the techniques described herein generally provide proposals for implementation of an AL at a base station (e.g., the network entity). One option includes the AL being implemented at a CU function of the base station. For example, the CU (e.g., the control plane of the CU) may receive a connection setup message for a remote UE (e.g., a first UE in this example). The CU (e.g., the AL implemented at the CU) may generally establish context information for the remote UE supporting the relayed communications between the remote UE and the base station via a relay UE (e.g., a second UE in this example). This may include establishing a relaying configuration for the remote UE identifying multiplexing and forwarding information for the connection between the relay UE and a DU of the base station, e.g., a DU associated with the CU of the base station. The CU may transmit an indication of the relaying configuration to the DU, but without including the UE context information of the remote UE. Accordingly, the DU in this option may not be aware of the specific remote UE. Instead, the AL at the CU may manage aspects of establishing UE context information for the remote UE, such as establishing a local remote UE identifier (ID), establishing bearer(s) for the remote UE, establishing/managing mappings between the remote UE bearers and a sidelink connection (or Wi-Fi connection, Bluetooth connection, etc.) between the remote UE and the relay UE, mappings between the sidelink (or other) connections to the Uu connection (e.g., RLC channels) between the relay UE and the DU, and the like. Accordingly, the base station may communicate with the remote UE via the relay UE according to the UE context information and the relaying configuration. Thus, the DU in this example may route remote UE traffic according to the relaying configuration, without an understanding that the traffic being relayed is for a specific remote UE.

Another option (e.g., a second option) may include the AL being implemented at the DU of the base station. In this option, the DU may be configured with the remote UE context information (e.g., is aware that the remote UE, the second UE in this example, is connected via the relay UE, the first UE in this example). The CU (e.g., in its own AL implementation, in some examples) may manage aspects of the techniques described in the first option, but may inform the DU of the context information for the remote UE. Accordingly, the AL implemented at the DU may provide Uu AL support for control and user plane data between the CU and the remote/relay UE, such as AL header support for downlink traffic, routing of uplink AL protocol data unit (PDU) to the remote UE CU user plane, etc. In some aspects of this second option, radio bearers may include the AL implemented at the DU providing bearer support for the remote UE. For example, this may include the Uu AL implemented at the DU providing support for both signaling radio bearers (SRBs) and data radio bearers (DRBs) for the remote UE. In other examples, aspects of bearer support may be split between the DU and CU (such as the AL CU managing aspects of SRBs with the AL DU managing aspects of DRBs, or vice versa).

Aspects of the disclosure are initially described in the context of wireless communications systems. Aspects of the disclosure are further illustrated by and described with reference to apparatus diagrams, system diagrams, and flowcharts that relate to Uu adaptation layer support for layer two relaying.

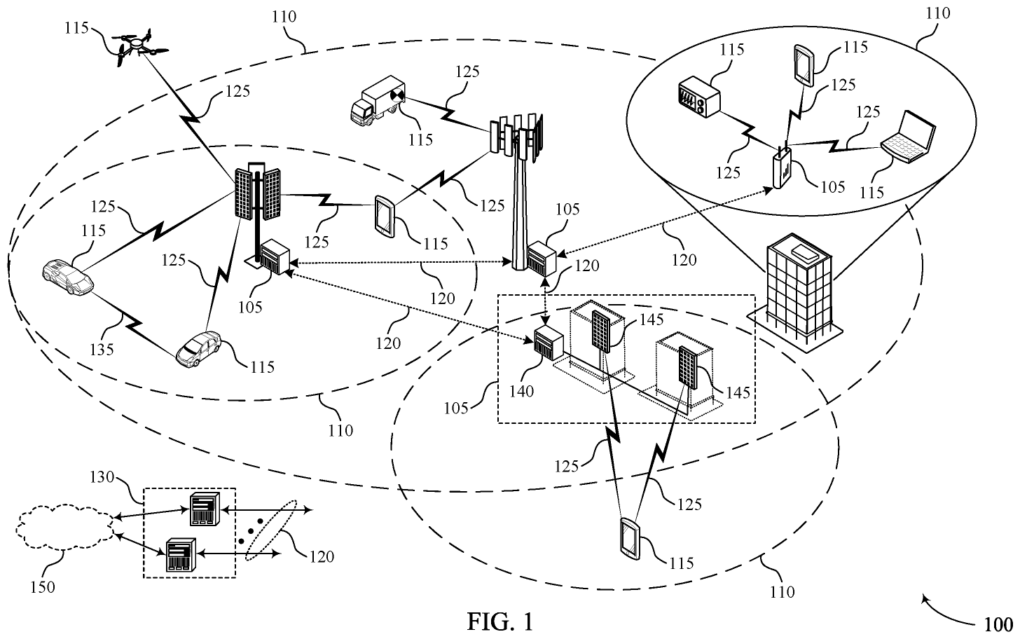

FIG. 1 illustrates an example of a wireless communications system 100 that supports Uu adaptation layer support for layer two relaying in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A CU of a network entity (e.g., a CU implemented within a base station 105 configured with the CU/DU functional split) may receive, from a first UE (e.g., a remote UE in this example) via a second UE (e.g., a relay UE in this example), a connection setup request message for a first UE. The CU may establish UE context information for the first UE at an AL of the CU, the UE context information based at least in part on communications between the first UE and the network entity via the second UE. The CU may transmit, to one or more DUs associated with the CU, an indication of a relaying configuration for the first UE connecting to the network entity via the second UE, the relaying configuration comprising multiplexing and forwarding information for a connection between the second UE and each DU of the one or more DU. The CU may communicate with the first UE via the second UE according to the UE context information and the relaying configuration.

A DU of a network entity (e.g., a DU implemented within a base station 105 configured with the CU/DU functional split) may receive, from a CU of the network entity, an indication of a relaying configuration for a first UE (e.g., the remote UE in this example) connecting to the network entity via a second UE (e.g., the relay UE in this example). The DU may determine, based at least in part on the relaying configuration, multiplexing and forwarding information for the connection between the second UE and the DU. The DU may relay communications between the first UE and the network entity via the second UE according to the multiplexing and forwarding information.

A DU of a network entity (e.g., a DU implemented within a base station 105 configured with the CU/DU functional split) may obtain, from CU of the network entity, a context setup request message for a first UE (e.g., the relay UE in this example). The DU may establish UE context information for the first UE at the CU, the UE context information based at least in part on communications between a second UE (e.g., the remote UE in this example) and the network entity via a first UE. The DU may establish, at an AL of the DU, a relaying configuration for the second UE connecting to the network entity via the first UE, the relaying configuration comprising multiplexing and forwarding information for a connection between the second UE and the DU. The DU may communicate with the second UE via the first UE according to the UE context information and the relaying configuration.

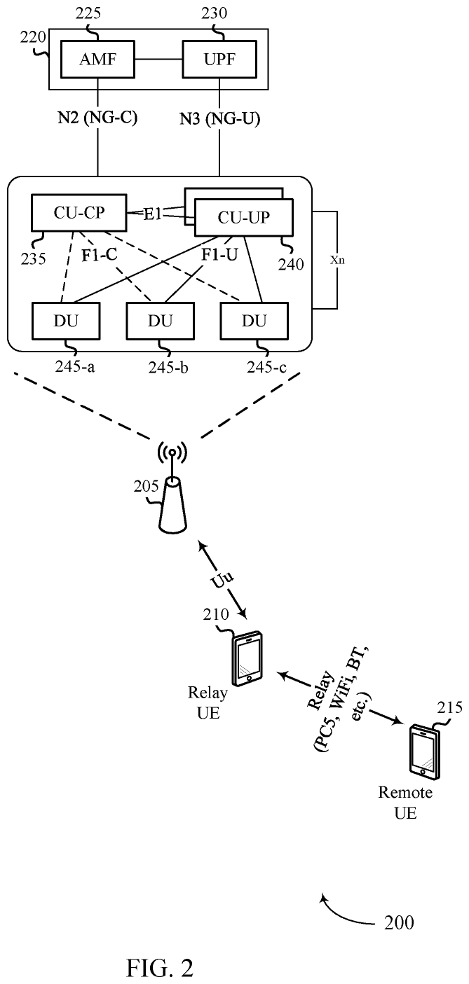

FIG. 2 illustrates an example of a wireless communication system 200 that supports Uu AL support for layer two relaying in accordance with aspects of the present disclosure. Wireless communication system 200 may implement aspects of wireless communication system 100. Wireless communication system 200 may include base station 205, UE 210, and UE 215, which may be examples of the corresponding devices described herein. In the non-limiting example illustrated in FIG. 2, UE 210 may be considered an example of a relay UE and UE 215 may be considered an example of a remote UE. That is, generally the relay UE may support or otherwise be configured to relay wireless communications between the remote UE and base station 205.

Aspects of wireless communication system 200 may support single-hop, sidelink-based (or other connection types), L2 and layer 3 (L3) based UE-to-network (U2N) relaying operations. For example, aspects of wireless communication system 200 may provide mechanisms for control plane procedures for U2N, including RRC connection management, system information delivery, paging mechanism and access control for the remote UE (e.g., UE 215 in this example). Base station 205 may communicate within core network 220, such as with an access management function (AMF) 225 via a N2 interface and/or with a user-plane function (UPF) 230 within core network 220.

Wireless communication system 200 may support base station 205 including a Uu interface AL that manage aspects of wireless communications between base station 205 and UE(s). For example, this may include the AL managing one or more aspects of L2 relaying operations between a relay UE (e.g., UE 210 in this example) and one or more remote UE(s) (which may include UE 215 in this example). This may include end-to-end bearers (e.g., SRB(s) and/or DRB(s)) of the remote UE being N:1 mapped and data multiplexed over one (or more) Uu RLC channel(s) of the relay UE. For example, base station 205 may configure the relay UE with Uu RLC channel(s) for the remote UE bearers during connection setup/resume/reestablishment procedures.

However, wireless communication system 200 may also support a CU/DU functional split at base station 205. For example, the CU (which may include a CU-control plane (CU-CP) 235 and one or more CU-user plane(s) (CU-UP) (s) 240) may manage aspects of higher layer functionality (e.g., PDCP, IP, NAS, and the like) while the DU 245 (with three DU 245 being shown by way of example only) manages aspects of lower layer functionality (e.g., PHY, MAC layer, RLC layer, and the like) at base station 205. For example, the DU 245 may be configured with three DU, include DU 245-a, DU 245-b, and DU 245-c.

Generally, the CU-CP 235 may be connected to DU 245 via an F1-C interface and one DU 245 may be connected to one CU-CP 235. CU-CP 235 generally identifies or otherwise selects the appropriate CU-UP(s) 240 for requested services for a UE. CU-UP(s) 240 may be connected to CU-CP 235 via an E1 interface and connected to DU 245 via an F1-U interface. One CU-UP(s) 240 may be connected to only one CU-CP 235 and one DU 245 may be connected to multiple CU-UP(s) 240 under the control/management of the same CU-CP 235. One CU-UP(s) 240 may be connected to multiple DU 245 under the control of the same CU-CP 235. Connectivity between CU-UP(s) 240 and DU 245 may be established by CU-CP 235 (e.g., using bearer context management functions). Data forwarding between CU-UP(s) 240 may be supported via an Xn-U interface.

Uu AL and L2 relaying operations generally rely on support from base station 205. For example, different end-to-end radio bearers (SRB/DRB) associated with the same remote UEs may be subject to N:1 mapping and data multiplexing over one Uu RLC channel. Base station 205 generally configures the relay UE with Uu RLC channel(s) (CH) (s) for the remote UE bearers (e.g., SRB1, SRB2, DRB(s)), such as during the remote UE connection setup/resume/reestablishment procedures. Base station 205 generally transmits, sends, or otherwise provides the RRC reconfiguration message to the relay UE, such as during remote UE indirect-to-direct patch switch, to release the remote UE specific Uu RLC CH(s) and PC5 RLC CHs. The AL header generally carries or otherwise conveys an indication of the local remote UE identifier (ID) (generally assigned by base station 205) and the remote UE bearer identifier(s).

However, conventional networks do not define where the AL is configured within the CU/DU split of base station 205. That is, such conventional networks do not provide for the AL to be implemented at the CU or the DU of the CU/DU functional split of base station 205. Accordingly, such networks do not provide for which function performs the Uu AL and L2 relaying operations to be supported by base station 205. This may disrupt relayed communications between the remote UE and base station, via the relay UE.

Accordingly, aspects of the techniques described herein provide options/proposals on how base station 205 can support such relaying operations when configured according to the CU/DU functional split. One option (e.g., a first option) broadly includes the AL being implemented at the CU and another option (e.g., a second option) broadly includes the AL being implemented at the DU. Some examples of the second option (DU approach) may include at least some degree of AL functionality being also implemented at the CU. In some aspects of the second option, radio bearers may include the AL implemented at the DU providing bearer support for the remote UE. For example, this may include the Uu AL implemented at the DU providing support for both SRBs and DRBs for the remote UE. In other examples, aspects of bearer support may be split between the DU and CU (such as the AL CU managing aspects of SRBs with the AL DU managing aspects of DRBs, or vice versa).

For example, UE 215 may be a remote UE that does not have a direct connection with base station 205. However, UE 215 (e.g., the remote UE, which may be considered the first UE in this first option) and UE 210 (e.g., the relay UE, which may be considered the second UE in this first option) may be configured with or otherwise support relay operations via a connection between the remote UE and the relay UE (such as a sidelink (PC5) connection, a Wi-Fi connection, a Bluetooth connection, or any other connection type supporting wireless communications). Accordingly, UE 210 and UE 215 may perform a relay discovery and connection procedure where the relay connection is established between the relay UE and the remote UE. If UE 210 is operating in a RRC idle or inactive state (e.g., the relay UE), UE 210 may transition to an RRC connected state. Otherwise, UE 210 may transmit or otherwise provide a connection setup request message (e.g., any RRC connection setup request message, such as an RRC setup request, RRC resume request, RRC reestablishment request, and the like) to base station 205 for UE 215. Generally, the connection setup request message may be received at a DU 245 of base station 205 that is connected to UE 210 and provided to CU-CP 235 via the F1-C interface.

Generally, the CU (e.g., CU-CP 235) may select, configure, or otherwise establish UE context information for the remote UE (e.g., relay context information based on the remote UE connecting to base station 205 via the relay UE). In the first option where the AL is implemented at the CU, the UE context information may be established at the AL implemented in CU-CP 235. In this first option, the CU (e.g., CU-CP 235) may transmit or otherwise provide (e.g., via the F1-C interface) an indication of a relaying configuration for the remote UE to a DU 245. For example, CU-CP 235 may select, configure, or otherwise establish the relaying configuration for the remote UE at the AL implemented at CU-CP 235.

In the second option where the AL is implemented at the DU, the UE context information may be selected, configured, or otherwise established at the AL implemented at the DU 245. Broadly, the relaying configuration includes, at least in part, the multiplexing and forwarding information for the connection between the relay UE and the DU 245, for the connection between the relay UE and the remote UE, and the like (as is discussed in greater detail below). For example, the relaying configuration may include mapping/multiplexing information for the radio bearers of the remote UE and the connection between the remote UE and the relay UE, the connection between the remote UE and relay UE to the connection between the relay UE and DU 245, and the like.

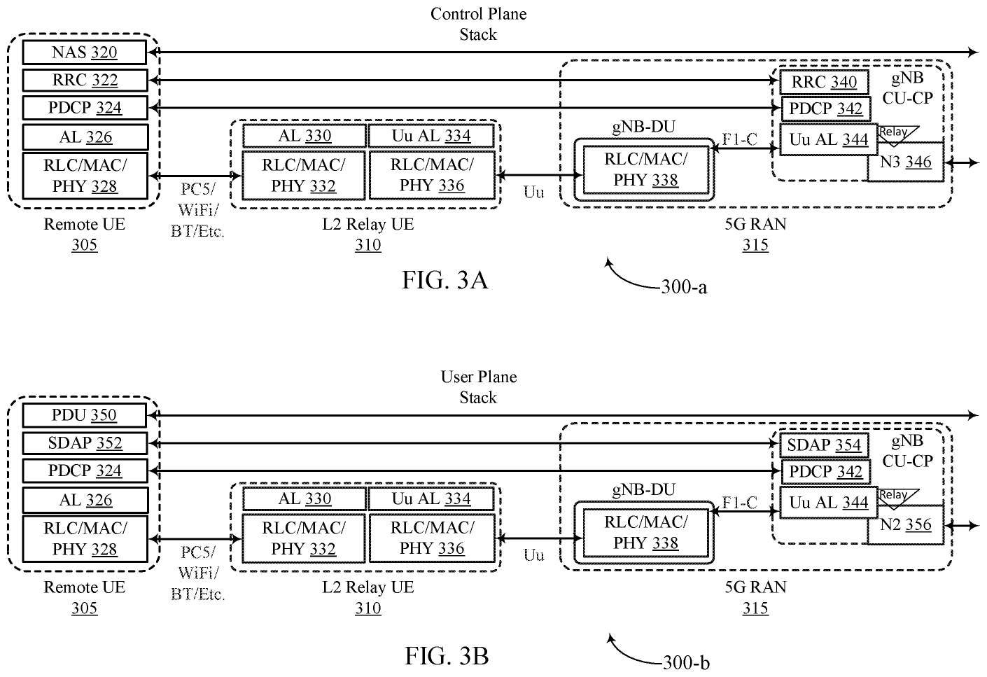

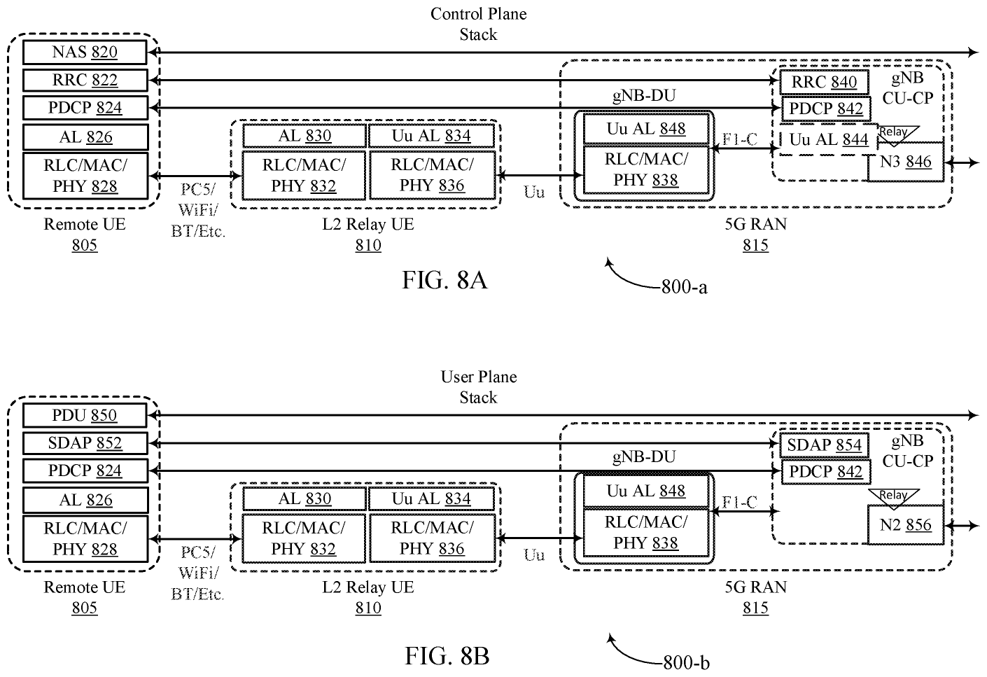

Accordingly, the remote UE (e.g., UE 215 in this example) may communicate with base station 205 via the relay UE (e.g., UE 210 in this example) according to the relaying configuration. More detailed discussions of the first option are provided with respect to FIGS. 3-7 below with more detailed discussions of the second option are provided with respect to FIGS. 8-10.

FIG. 3 illustrates an example of a protocol stack 300 that supports Uu AL support for layer two relaying in accordance with aspects of the present disclosure. Protocol stack 300 may implement aspects of wireless communication systems 100 and/or 200. Aspects of protocol stack 300 may be implemented by or implemented at a remote UE 305, a relay UE 310, and a fifth generation-radio access network (RAN) (5G RAN) 315, which may be examples of the corresponding devices described herein. For example, the 5G RAN 315 may generally correspond to a base station (e.g., gNB) and/or network entity (e.g., entity within the 5G RAN), with the base station configured with or otherwise supporting a CU/DU functional split (e.g., within the protocol stack). Protocol stack 300-aof FIG. 3A generally illustrates an example of a control plane (CP) protocol stack with protocol stack 300-b of FIG. 3B generally illustrates an example of a user plane (UP) protocol stack. Protocol stack 300 illustrates a non-limiting example of a protocol stack supporting option 1 where the AL is implemented at the CU.

Generally, each stack or layer with protocol stack 300 may generally correspond to a logical entity/function/mechanism with a wireless network, where each layer communicates with a corresponding layer at a distant end. For example and referring first to the control plane stack, protocol stack 300-a may include a non-access stratum (NAS) layer 320 implemented at remote UE 305 that supports a NAS signaling connection between the UE and an AMF within the core network (e.g., via a N2, NG-C interface between the 5G RAN and 5GC). Protocol stack 300-a may include a RRC layer implemented at remote UE 305 as RRC layer 322 communicating with the corresponding RRC layer 340 implemented at CU-CP (e.g., the gNB CU-CP). The RRC layer generally monitors, controls, or otherwise manages aspects of connection establishment and release functions, broadcast of system information, radio bearer establishment, reconfiguration and release, RRC connection mobility procedures, paging, and the like.

Protocol stack 300-a may also include a PDCP layer implemented at remote UE 305 at PDCP layer 324 communicating with the corresponding PDCP layer 342 implemented at CU-CP. The PDCP layer in the control plane generally monitors, controls, or otherwise manages aspects of sequence numbering, ciphering/deciphering, integrity protection, etc. Protocol stack 300-a may also include an AL implemented at remote UE 305 at AL 326. In this first option, AL 326 may generally communicate with Uu AL 344 of CU-CP. For example, remote UE 305 may include AL 326 communicating with AL 330 of relay UE 310 (e.g., managing aspects of the sidelink, Wi-Fi, Bluetooth, etc., connection between remote UE 305 and relay UE 310). Similarly, relay UE 310 may include a Uu AL 334 communicating with Uu AL 348 of the DU of 5G RAN 315 (e.g. the network entity in this example). The AL generally monitors, controls, or otherwise manages aspects of carrying F1 specific information/routing information, such as backhaul information managing a point-to-point (PTP) link.

Protocol stack 300-a may also generally include one or more layers supporting the physical link between wireless nodes, such as an RLC layer, MAC layer, PHY layer, etc. The RLC layer generally monitors, controls, or otherwise manages aspects of transfer of upper layer PDUs to the MAC layer through logical channels, sequence numbering, error connection, etc. The MAC layer generally monitors, controls, or otherwise manages aspects of logical-to-transport channel mapping, multiplexing MAC service data units (SDUs) of logical channels to transport block (TB) for transmission, and the like. The PHY layer generally monitors, controls, or otherwise manages aspects of modulation/demodulation, coding/decoding, antenna mapping, etc. For example, remote UE 305 may include a RLC/MAC/PHY layer 328 communicating with RLC/MAC/PHY layer 332 of relay UE 310 (e.g., managing aspects of the sidelink, Wi-Fi, Bluetooth, etc., connection between remote UE 305 and relay UE 310. Similarly, relay UE 310 may include a RLC/MAC/PHY layer 336 communicating with RLC/MAC/PHY layer 338 of the DU of 5G RAN 315 (e.g. the network entity in this example). The CU-CP may include a N3 interface 346 managing aspects of the communications between the 5G RAN and a UPF within the 5GC.

Referring next to protocol stack 300-b of FIG. 3B illustrating the user plane stack, the user plane stack may share many features with the control plane stack (e.g., PDCP, AL, RLC/MAC/PHY layers. These layers may generally perform similar functions as discussed with respect to the control plane stack, but with some changes related to user plane traffic. For example, the PDCP layer in the user plane may manage aspects of header compression/decompression, transfer of user data to lower layers, reordering and duplicate detection, and the like.

The remote UE 305, in the user plane, may include a PDU layer 350 implemented at remote UE 305 that monitors, controls, or otherwise manages aspects of PDU sessions between remote UE 305 and the core network (e.g., 5GC). Protocol stack 300-b may also include a service and data adaptation protocol (SDAP) layer implemented at remote UE 305 at SDAP layer 352 communicating with the SDAP layer 354 implemented at CU-CP. The SDAP layer generally monitors, controls, or otherwise manages aspects of mapping between quality-of-service (QOS) flow bearers to DRBs, downlink and uplink packet marking of QoS flow IDs (QFIs), and the like. Protocol stack 300-b may also include a N2 interface 356 managing aspects of the communications between the 5G RAN and a AMF within the 5GC.

Implementation of the AL at the CU (e.g., Uu AL 344 at CU-CP) may support Uu AL and L2 relaying support by the network entity (e.g., a 5G RAN entity, such as a base station including the CU/DU functional split). For example, the relay UE 310 may transmit or otherwise provide a connection setup request message for the remote UE 305. In response, the CU (e.g., CU-CP) may establish context information for the remote UE (e.g., based on the communications between the 5G RAN 315 and the remote UE 305 being via the relay UE 310). This may include CU-CP establishing a local remote UE ID for the remote UE 305 (e.g., an identifier used to distinguish the remote UE 305 during the relayed communications). This may include the CU-CP establishing relaying configuration for the communications with the remote UE 305 via the relay UE 310. This may include association and context for the relay UE 310 and remote UE 305 establishment and maintenance. For example, this may include the association for remote UE(s) connected to the relay UE 310 (e.g., relay UE 310 may support multiple remote UEs), remote UE and relay UE sidelink L2 IDs, remote UE e2e bearers (e.g., SRB1, SRB2, DRB(s)), and the like.

This may include the CU-CP establishing multiplexing and bearer management information (e.g., relaying configuration including multiplexing and forwarding information). For example, this may include the multiplexing of remote UE bearers to relaying Uu RLC channels, an N:1 bearer mapping between the remote UE e2e bearers to the PC5 RLC channel(s) and the PC5 RLC channel(s) to the Uu RLC channel(s), and the like. This may include relaying Uu/PC5 RLC channel ID assignment, relaying configuration (e.g., Uu and PC5 RLC channel management), and the like. In some examples, this may include e2e QoS split management for relaying (e.g., determine the QoS split for the Uu RLC channel and PC5 RLC channel that complies with the e2e QoS for the remote UE 305 SRB/DRB mapped to the RLC channels). This may include the CU-CP performing Uu AL support, such as AL header management, mapping of AL PDUs to the remote UE PDCP layer (e.g., for uplink traffic) or RLC channel entity (e.g., for downlink traffic). The user plane function of the CU (e.g., CU-UP) may also manage aspects of the Uu AL support for the UP data, such as AL header management, mapping of AL PDU to the remote UE PDCP layer (e.g. for uplink traffic) or the RLC channel entity (e.g., for downlink traffic).

The CU (e.g., CU-CP) may transmit or otherwise provide an indication of the relaying configuration to the DU of the 5G RAN 315 (e.g., the network entity). The DU may use the relaying configuration to identify or otherwise determine the multiplexing and forwarding information. In some examples, the CU may not provide any indication of the remote UE context information to the DU. Accordingly, the DU may support relaying Uu RLC channels according to the relaying configuration and providing the RLC/MAC configurations to the CU-CP. That is, the DU may relay communications to/from the remote UE 305 via the relay UE 310, but may not be aware of the context information of the remote UE 305. For example, the DU may route traffic according to the relaying configuration provided by the CU-CP (e.g., according to the multiplexing and bearer mapping information), but may be unaware that some of the traffic is for the relay UE 310 while other traffic is for remote UE 305 connecting to 5G RAN 315 via relay UE 310. Accordingly, the CU of 5G RAN 315 may communicate with the remote UE 305 via relay UE 310 according to the context information of the remote UE 305 and the relaying configuration.

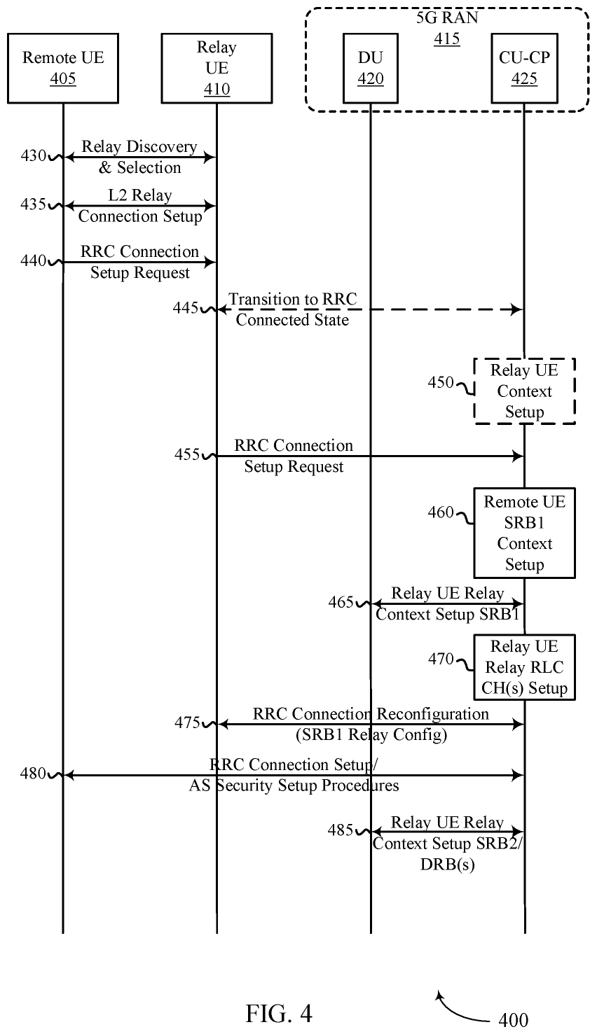

FIG. 4 illustrates an example of a process 400 that supports Uu AL support for layer two relaying in accordance with aspects of the present disclosure. Process 400 may implement aspects of wireless communication systems 100 and/or 200 and/or protocol stack 300. Process 400 may be implemented at or implemented by a remote UE 405, a relay UE 410, and a 5G RAN 415, which may be examples of the corresponding devices described herein. For example, remote UE 405 may be an example of a first UE in this first option and relay UE 410 may be an example of a second UE in this first option. NG RAN 415 may be an example of a network entity (e.g., an entity within the NG RAN) and/or base station supporting a CU/DU functional split. For example, NG RAN 415 may include a DU 420 and a CU-CP 425, which may also be examples of the corresponding devices described herein.

At 430, remote UE 405 and relay UE 410 may perform a relay discover and selection process. For example, remote UE 405 may determine that it is not within range or otherwise unable to perform direct communications with NG RAN 415. Accordingly, remote UE 405 may monitor for one or more signals (e.g., broadcast signals, reference signals, Uu signals, sidelink signals, etc.) from other UEs that are configured with or otherwise support relay communications between remote UE 405 and NG RAN 415. Based on detecting such signals as well as the signal quality, remote UE 405 may establish one or more channels. In some examples, the channel between remote UE 405 and relay UE 410 may be examples of a sidelink channel, a Wi-Fi channel, a Bluetooth channel, or any other wireless channel supporting communications between remote UE 405 and relay UE 410. In some examples, the connection between remote UE 405 and relay UE 410 may also be referred to as a sidelink channel.

At 435, remote UE 405 and relay UE 410 may perform a L2 relay connection setup procedure. For example, remote UE 405 and relay UE 410 may establish one or more logical entities, such as an RLC entity, MAC entity, PHY entity, etc., managing aspects of the connection between remote UE 405 and relay UE 410.

At 440, remote UE 405 may transmit or otherwise provide a RRC connection setup request message. Generally, the RRC connection setup request message may carry or otherwise convey an indication of a request for connection establishment with NG RAN 415, e.g., an indirect connection via relay UE 410.

At 445, relay UE 410 and CU-CP 425 may optionally transition to an RRC connected state. That is, in some examples relay UE 410 may be operating in a RRC idle or inactive state upon receiving the RRC connection setup request message. Accordingly, relay UE 410 may transition to the RRC connected state and optionally establish UE context information for the relay UE 410 at 450. However, in other examples relay UE 410 may already be operating in the RRC connected state and the features performed at 445 and 450 may be unnecessary.

At 455, relay UE 410 may transmit or otherwise provide (and CU-CP may receive or otherwise obtain) a RRC connection setup request message for the remote UE 405. That is, the RRC connection setup request message may carry or otherwise convey an indication that remote UE 405 is trying to establish a connection with NG RAN 415 via relay UE 410. Although the techniques discussed herein generally refer to the message as an RRC connection setup request message, it is to be understood that the message may also be an example of an RRC setup request (RRCSetupRequest) message, a RRC resume request (RRCResumeRequest), an RRC reestablishment request (RRCReestablishmentRequest) used to transition relay UE 410 to the RRC connected state.

Upon receiving the RRC connection setup request message from for the remote UE 405, the CU-CP 425 may generally perform certain functions based at least in part on the AL being implemented at the CU. For example, the CU-CP 425 may generally establish a context for the remote UE 405 e2e SRB0, SRB1, etc. The CU-CP 425 may decide the remote UE 405 multiplexing to the relaying Uu RLC channel(s). The CU-CP 425 may perform relay UE 410 context setup procedures with DU 420 and setup the relay UE 410 relaying context. The CU-CP 425 may, after successful remote UE 405 context setup, setup the relay UE 410 context for the remote UE 405 SBR2/DRBs with DU 420. The CU-CP 425 may indicate the remote UE 405 SRB1/SBR2/DRB(s) relaying RLC channel configuration to the relay UE 410 and to the remote UE 405 (e.g., via RRC message(s)). The CU-CP 425 may assign the Uu/PC5 RLC channel identifiers for the remote UE 405 e2e SRB1/SRB2/DRB(s).

The DU 420 may generally identify or otherwise determine the RLC/MAC/PHY layer configuration for the relay UE 410 relaying RLC channels, setup the relay UE relaying context (e.g., relaying configuration), indicate the relaying context to the CU-CP 425, and the like.

For example, at 460 the CU-CP 425 may identify or otherwise determine the remote UE context setup. For example, the CU-CP 425 (e.g., at an AL and/or other layer(s) implemented at CU-CP 425) may CU-CP 425 may setup the relay UE context for the remote UE SBR(s)/DRB(s), such as for SRB1 in this example. In response and at 465, the CU-CP 425 may transmit or otherwise convey one or more context information messages to the DU 420 configuring or otherwise identifying the UE context information for the remote UE 405 for SRB1 (e.g., to support RRC and/or NAS message exchanges, such as those using a dedicated control channel (DCCH) logical channel).

At 470, CU-CP 425 may establish or otherwise configure the relay UE relaying RLC channel(s). This may include establishing one or more RLC channels for relay UE 410 to use for carrying or otherwise conveying relayed communications between remote UE 405 and NG RAN 415. For example, CU-CP 425 may establish one or more RLC channels to carry messages between remote UE 405 and relay UE 410 and/or between relay UE 410 and NG RAN 415. CU-CP 425 may map or otherwise multiplex SRB1 onto the one or more relaying RLC channels (although DU 420 may not be aware of such mapping).

At 475, CU-CP 425 may transmit or otherwise provide an RRC connection reconfiguration message to relay UE 410. In some examples, the RRC connection reconfiguration message may carry or otherwise convey an indication of the SRB1 relaying configuration established by CU-CP 425. The relaying configuration may include or otherwise identify the Uu RLC channels, the PC5 RLC channel configuration, the AL configuration for the Uu and local links, and the like. This may inform relay UE 410 of the SRB1 relaying configuration to be used for the communications between remote UE 405 and NG RAN 415 via relay UE 410.

Similarly, at 480 CU-CP 425 may transmit or otherwise provide an RRC connection setup/AS security setup procedures message to remote UE 405. In some examples, the message may carry or otherwise convey an indication of the SRB1 relaying configuration established by CU-CP 425. The message may indicate or otherwise identify the SRB(s)/DRB(s) configuration, PC5 RLC channel configuration, AL configuration, and the like, for the sidelink (or other) channel between remote UE 405 and relay UE 410. This may inform remote UE 410 of the SRB1 relaying configuration to be used for the communications between remote UE 405 and NG RAN 415 via relay UE 410.

At 485, CU-CP 425 may transmit or otherwise convey one or more context information messages to the DU 420 configuring or otherwise identifying the UE context information for the remote UE 405 for SRB2 and/or other DRB(s) (e.g., to further support NAS message exchanges, such as those using the DCCH logical channel). The steps discussed above may be repeated for SRB2 (or otherwise SRBs, such as SRB3 supporting dual-connectivity functionality, and/or for DRB(s) carrying data). Accordingly, the CU-CP 425 implementing the AL (e.g., the Uu AL) may configure and manage the relaying configuration for wireless communications with remote UE 405, but the DU 420 may be unaware of remote UE 405 being part of the wireless communications.

As discussed above, the CU-CP 425 may establish, monitor, control, or otherwise manage aspects of the relaying and multiplexing configuration used for the wireless communications between remote UE 405 and NG RAN 415 via relay UE 410. In some examples, CU-CP 425 may rely on various criteria when determining or otherwise establishing such configurations, such as when deciding which remote UE bearers are multiplexed to a relay UE relaying RLC channel. One example may include CU-CP 425 using the remote UE bearers e2e QoS metrics. For example, the CU-CP 425 may identify or otherwise determine the e2e QoS for the bearer(s) of the remote UE 405 and establish a sidelink (or other channel type) QoS parameter for each sidelink channel and/or cellular (e.g., Uu) channel accordingly. Another example may include CU-CP 425 using the remote UE bearers having the same slicing requirements. For example, CU-CP 425 may identify or otherwise determine the slicing configuration for the bearer(s) of the remote UE and establish or otherwise configure the relaying configuration accordingly.

In some examples, the CU-CP 425 setting up new relaying RLC channels for the relay UE 410 if the existing relay UE's relaying RLC channels cannot satisfy the multiplexing criteria. CU-CP 425 may setup the relay UE context with DU 420 to establish the relaying RLC channels for the remote UE's SRB(s)/DRB(s). If the relaying RLC channels can satisfy the remote UE context (e.g., QoS/slicing requirements), CU-CP 425 may use the relaying RLC channels and the relay UE context information without new setup at the DU 420.

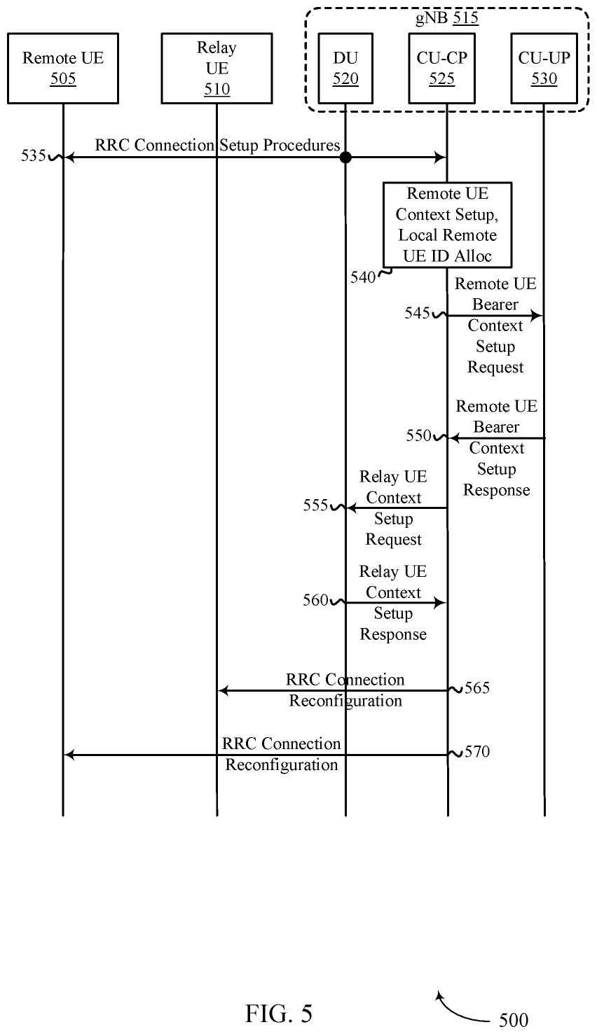

FIG. 5 illustrates an example of a process 500 that supports Uu AL support for layer two relaying in accordance with aspects of the present disclosure. Process 500 may implement aspects of wireless communication systems 100 and/or 200, protocol stack 300, and/or process 400. Process 500 may be implemented at or implemented by a remote UE 505, a relay UE 510, and a 5G RAN 515, which may be examples of the corresponding devices described herein. For example, remote UE 505 may be an example of a first UE in this first option and relay UE 510 may be an example of a second UE in this first option. NG RAN 515 may be an example of a network entity (e.g., an entity within the NG RAN) and/or base station supporting a CU/DU functional split. For example, NG RAN 515 may include a DU 520, a CU-CP 525 and/or a CU-UP 530, which may also be examples of the corresponding devices described herein.

As discussed above, aspects of the techniques described herein provide for implementation of a AL at a CU (e.g., CU-CP 525) of the network entity (e.g., NG RAN 515). Generally, the AL, alone or in combination with other layers of the network entity, may manage aspects of relaying operations for remote UE 505. For example, the CU may monitor, control, or otherwise manage aspects of determining e2e QoS/slicing configurations of remote UE 505, establishing bearer(s) to support those configurations, and establishment and mapping/multiplexing of channel(s) for the link between remote UE 505 and relay UE 510 as well as for the link between relay UE 510 and DU 520. In some aspects, the CU may establish, when not already present, such channels that support the QoS/slicing configuration of remote UE 505. However, in this first option the CU may not inform DU 520 of the context information of remote UE 505, but instead may manage the establishment and mapping/multiplexing configuration for the channels separately from DU 420. In some aspects, DU 520 may be unaware of remote UE 505 and/or that relay UE 510 is relaying communications between remote UE 505 and NG RAN 515.

At 535, remote UE 505, relay UE 510, and CU-CP 525 may perform RRC connection setup procedures, e.g., via DU 520. These procedures may generally correspond to the features discusses with respect to steps 430-455 of process 400 discussed above. Accordingly, CU-CP 525 may receive the RRC connection setup request message from relay UE 510 for remote UE 505.

At 540, CU-CP 525 establish context information for remote UE 505, such as establishing the local remote UE ID, determining bearer requirements of remote UE 505, and the like.

At 545, CU-CP 525 may transmit or otherwise provide (and CU-UP 530 may receive or otherwise obtain) a bearer context message for the remote UE 505. The bearer context message may carry otherwise convey an indication of bearer information for remote UE 505, such as user plane tunnelling information. In some examples, the message may include a remote UE E1AP bearer context setup request/modification message sent to CU-UP 530. The message may carry or otherwise convey the local remote UE ID assigned to remote UE 505. This information may be leveraged to support AL header and AL routing functionality within CU-UP 530.

At 550, CU-UP 530 may transmit or otherwise provide (and CU-CP 525 may receive or otherwise obtain) a bearer context setup response message for the remote UE 505. The bearer context setup response message may carry otherwise convey an indication/confirmation of the bearers established for the remote UE 505 to use for communications with NG RAN 515.

At 555, CU-CP 525 may transmit or otherwise provide (and DU 520 may receive or otherwise obtain) a context setup request message for the relay UE 510. In some examples, the message may be a F1AP UE context setup request/UE context modification request message sent for the relay UE 510. The message may carry or otherwise convey various information for the relay UE 510 to use for relaying communications between remote UE 505 and NG RAN 515. For example, the message may indicate a relaying SRB RLC channel list, which includes or otherwise identifies the RLC channel ID (e.g., the RLC channel between relay UE 510 and DU 520 carrying SRB traffic). In some examples, the message may indicate a relaying DRB RLC channel, which includes or otherwise identifies the RLC channel ID, RLC channel QoS, RLC mode, and the like, for the RLC channel between relay UE 510 and DU 520 carrying DRB traffic. In some examples, the message may indicate a sidelink (SL) DRB setup list, which includes a SL DRB ID, SL QOS, and the like, for the RLC (or sidelink, Wi-Fi, Bluetooth, etc.) channel between remote UE 505 and relay UE 510. DU 520 may modify and/or establish RLC channels according to the information carried in the message. For example, DU 520 may consider the split of the remote UE e2e QoS between the Uu RLC channel(s) and the PC5 RLC Channel(s) (e.g., the sidelink or other channel(s)).

At 560, DU 520 may respond by transmitting or otherwise providing (and CU-CP 525 may receive or otherwise obtain) a context setup response message for relay UE 510. In some examples, the message may be an F1AP UE context setup response/UE context modification response message sent for relay UE 510 context. The message may identify and/or confirm various information regarding the channels being used for relayed communications. For example, the message may include a relaying SRB RLC channel setup/modification list indicating the RLC channel ID(s) for the RLC/SL channels. The message may include a relaying SRB RLC channel failed list indicating the RLC channel ID of channels carrying SRB traffic that were unable to be established. The message may include a relaying DRB RLC channel setup/modification list indicating RLC channel ID(s) for channels carrying DRB traffic. The message may include a relaying DRB RLC channel failed list indicating the RLC channel ID of channels carrying DBR traffic that were unable to be established.

In some examples, DU 520 may transmit or otherwise provide a F1AP UE context modification required message to CU-CP 525 that carries or otherwise conveys an indication of the relaying SRB/DRB RLC channel(s) to be setup/modified list, which includes the RLC channel ID(s). In response, CU-CP 525 may respond by transmitting or otherwise providing an F1AP UE context modification confirm message, which includes the relaying SRB/DRB RLC channel list identifying channel(s) that were setup/modified as well as channel(s) that were failed to be setup/failed to be modified, including the RLC channel ID(s). These message exchanges may permit DU 520 and CU-CP 525 to ensure the appropriate channels are established/available to support relayed communications between remote UE 505 and NG RAN 515 according to the QoS requirements, slicing configuration, and the like.

At 565, CU-CP 525 may transmit or otherwise provide an RRC connection reconfiguration message to relay UE 510. In some examples, the RRC connection reconfiguration message may carry or otherwise convey an indication of the relaying configuration established by CU-CP 525. The relaying configuration may include or otherwise identify the Uu RLC channels, the PC5 RLC channel configuration, the AL configuration for the Uu and local links, and the like. This may inform relay UE 510 of the SRB/DRB relaying configuration to be used for the communications between remote UE 505 and NG RAN 515 via relay UE 510.

Similarly, at 570 CU-CP 525 may transmit or otherwise provide an RRC connection reconfiguration message to remote UE 505. In some examples, the message may carry or otherwise convey an indication of the relaying configuration established by CU-CP 525. The message may indicate or otherwise identify the SRB(s)/DRB(s) configuration, PC5 RLC channel configuration, AL configuration, and the like, for the sidelink (or other) channel between remote UE 505 and relay UE 510. This may inform remote UE 510 of the relaying configuration to be used for the communications between remote UE 505 and NG RAN 515 via relay UE 510.

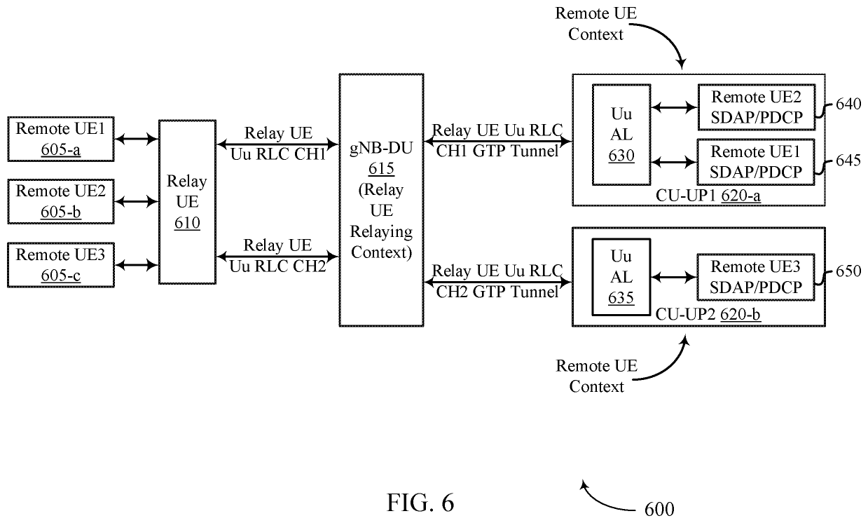

FIG. 6 illustrates an example of a wireless communication system 600 that supports Uu AL support for layer two relaying in accordance with aspects of the present disclosure. Wireless communication system 600 may implement aspects of wireless communication systems 100 and/or 200, protocol stack 300, and/or processes 400 and/or 500. Aspects of wireless communication system 600 may be implemented at or implemented by a remote UE 605, a relay UE 610, a DU 615, and CU-UP 620, which may be examples of the corresponding devices described herein. For example, remote UE 605 may be an example of a first UE in this first option and relay UE 610 may be an example of a second UE in this first option. DU 615 and CU-UP 620 may be associated with a NG RAN, which may be an example of a network entity (e.g., an entity within the NG RAN) and/or base station supporting a CU/DU functional split. Aspects of wireless communication system 600 illustrate an example of a network supporting remote UE user plane data routing on F1-U.

As discussed above, aspects of the techniques described herein provide for implementation of a AL at a CU (e.g., CU-CP) of the network entity. Generally, the AL, alone or in combination with other layers of the network entity, may manage aspects of relaying operations for remote UE 605. For example, the CU may monitor, control, or otherwise manage aspects of determining e2e QoS/slicing configurations of remote UE 605, establishing bearer(s) to support those configurations, and establishment and mapping/multiplexing of channel(s) for the link between remote UE 605 and relay UE 610 as well as for the link between relay UE 610 and DU 615. In some aspects, the CU may establish, when not already present, such channels that support the QoS/slicing configuration of remote UE 605. However, in this first option the CU may not inform DU 615 of the context information of remote UE 605, but instead may manage the establishment and mapping/multiplexing configuration for the channels separately from DU 615. In some aspects, DU 615 may be unaware of remote UE 605 and/or that relay UE 610 is relaying communications between remote UE 605 and the NG RAN.

Generally, UE user plane traffic is sent between the DU 615 and CU-UP 620 based on uplink user plane tunneling information, which may be exchanged for each UE's DRB during the UE context setup messages discussed above. For example, on the E1AP, CU-UP 620 may allocate an uplink tunneling information during the UE bearer context setup procedures and indicate this to the CU-CP for each DRB configured for the UE in the CU-CP. The CU-CP includes the uplink user plane tunneling information in the UE context setup messages sent to DU 615 for the corresponding DRB.

In this first example where the AL support is implemented at the CU, DU 615 may be configure with relaying RLC channels, but not the DRB(s) of the remote UE 605. As DU 615 is unaware of the context information for remote UE 605, providing different uplink user plane tunnelling information for each remote UE DRB to the DU 615 may not be acceptable. That is, in order to simplify DU 615 operations (e.g., without any remote UE context information), the techniques described herein include configuring a single uplink user plane tunneling information for the relaying Uu RLC channel(s) associated with a relay UE 610. To enable this, changes to the E1AP CU-CP/CU-UP procedures may be provided. In some aspects, the remote UE uplink control plane data received on a relaying RLC channel corresponding to SRB(s) may be routed to the CU-CP, where the CU-CP identifies the remote UE PDCP entity based on the AL header.

Accordingly, in the non-limiting example illustrated in wireless communication system 600, relay UE 610 is mapped to three remote UE 605 (e.g., remote UE 605-a corresponding to UE1, remote UE 605-b corresponding to UE2, and remote UE 605-c corresponding to UE3). As discussed above, DU 615 may be configured with context information for relay UE 610, but not for remote UE 605. However, CU-UP 620 may be configured with remote UE context information. In the non-limiting example illustrated in FIG. 6, UE1 and UE2 may be multiplexed onto a single general packet radio service (GPRS) tunneling protocol (GTP) tunnel that is mapped, via a relay UE Uu RLC channel 1, to CU-UP 620-a while UE3 is mapped onto a GTP tunnel that is mapped, via a relay UE Uu RLC channel 2, to CU-UP 620-b (e.g., separate CU-UPs). Each CU-UP 620 may be configured with or otherwise support AL functionality, such as AL 630 of CU-UP 620-a and AL 635 of CU-UP 620-b.

To support a single uplink user plane tunneling information associated with a relaying Uu RLC channel (e.g., a one-to-one mapping between the user plane tunnel and a RLC channel between relay UE 610 and DU 615), the CU may indicate or otherwise propose uplink user plane tunneling information to the CU-UP 620 for the remote UE DRB(s). The CU-CP may host the remote UE's DRB(s) mapped to the same relaying Uu RLC channel on the same CU-UP 620. However, one or more relaying RLC channels may be served by the same CU-UP 620. In some examples, CU-CP may propose the same uplink user plane tunneling information in the remote UE E1AP bearer context messages sent to the CU-UP 620 for configuring remote UE bearers multiplexed to the same relaying RLC channel.

In some examples, CU-UP 620 may accept the CU-CP proposed uplink user plane tunneling information, such as when the local remote UE ID is present for the UE E1AP bearer context messages, and allocate the same tunneling addresses/IDs for the DRB(s). The CU-CP may include the received uplink user plane tunneling information in the relay UE F1AP UE context message sent to gNB-DU (e.g., DU 615). In some aspects, the relaying RLC channel setup/modify list may carry or otherwise convey an indication of the RLC channel ID, the RLC channel QoS, the RLC mode, the uplink user plane tunneling information (e.g., CU-UP uplink user planet tunneling information). In some aspects, DU 615 may include downlink user plane tunneling information in the relay UE F1AP UE context response messages sent to CU-CP for each relaying RLC channel. In some aspects, the relaying RLC channel setup/modified list may carry or otherwise convey information including the RLC channel ID; downlink user plane tunneling information, and the like. The CU-CP may inform CU-UP 620 of the downlink user plane tunneling information received from DU 615 to route the downlink traffic over E1AP.

For uplink traffic, the CU-UP 610 Uu AL may route the received packets to the corresponding UE PDCP entity based on the AL header (e.g., indicating the remote UE ID, remote UE bearer ID). For example, CU-UP 620-a may route uplink traffic from UE1 to the SDAP/PDCP entity 645 and route uplink traffic from UE2 to SDAP/PDCP entity 640. Similarly, CU-UP 620-b may route uplink traffic from UE3 to SDAP/PDCP entity 650 for UE3.

For downlink traffic, CU-UP 620 may route downlink traffic to the corresponding RLC channel downlink user plane tunnel based on the remote UE ID and bearer ID. For example, CU-UP 620-a may route downlink traffic (e.g., AL 630) received from SDAP/PDCP entity 645 to the relaying RLC channel 1 for remote UE 605-a and route downlink traffic (e.g., AL 630) received from SDAP/PDCP entity 640 to relaying RLC channel 1 for remote UE 605-b. CU-UP 620-b may route downlink traffic (e.g., AL 635) received from SDAP/PDCP entity 650 to relaying RLC channel 2 for remote UE 605-c.

Accordingly, the AL implemented at CU (CP and/or UP) may route DRB traffic between DU 615 and the appropriate relaying RLC channel according to the GTP tunneling information associated with each remote UE 605.

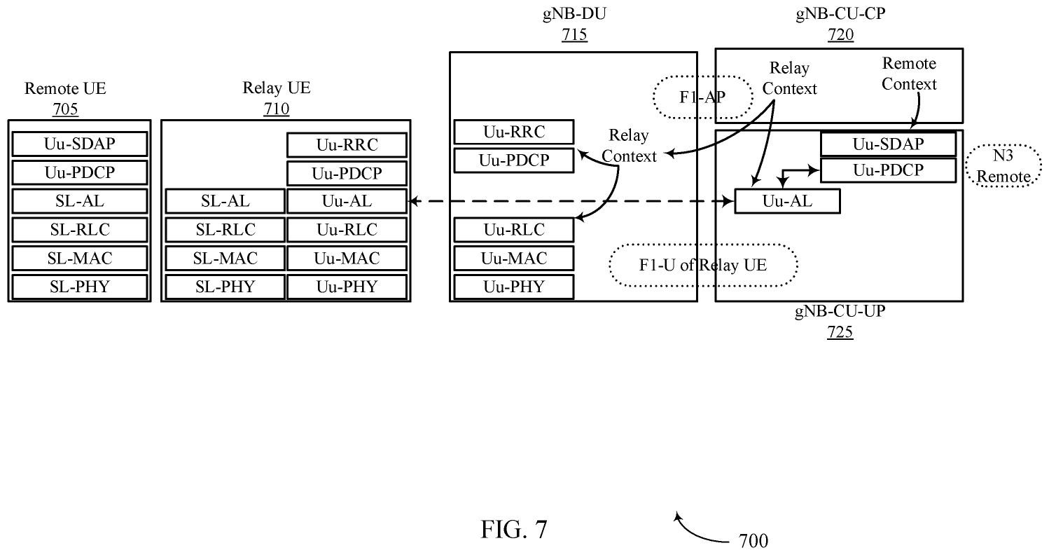

FIG. 7 illustrates an example of a wireless communication system 700 that supports Uu AL support for layer two relaying in accordance with aspects of the present disclosure. Wireless communication system 700 may implement aspects of wireless communication systems 100, 200 and/or 600, protocol stack 300, and/or processes 400 and/or 500. Aspects of wireless communication system 700 may be implemented at or implemented by a remote UE 705, a relay UE 710, and a NG RAN (e.g., network entity), which may include a DU 715, a CU-CP 720, and CU-UP 725, which may be examples of the corresponding devices described herein. For example, remote 7E 605 may be an example of a first UE in this first option and relay UE 710 may be an example of a second UE in this first option. DU 715, CU-CP 720 and CU-UP 725 may be associated with a NG RAN, which may be an example of a network entity (e.g., an entity within the NG RAN) and/or base station supporting a CU/DU functional split. Aspects of wireless communication system 700 illustrate an example of a network supporting remote UE user plane data routing on F1-U. Remote UE 705, relay UE 710, and the NG RAN may include a protocol stack, which may function such as is discussed with reference to FIG. 3.

As discussed above, aspects of the techniques described herein provide for implementation of a AL at a CU (e.g., CU-CP 720 and/or CU-UP 725) of the network entity. Generally, the AL, alone or in combination with other layers of the network entity, may manage aspects of relaying operations for remote UE 705. For example, the CU may monitor, control, or otherwise manage aspects of determining e2e QoS/slicing configurations of remote UE 705, establishing bearer(s) to support those configurations, and establishment and mapping/multiplexing of channel(s) for the link between remote UE 705 and relay UE 710 as well as for the link between relay UE 710 and DU 715. In some aspects, the CU may establish, when not already present, such channels that support the QoS/slicing configuration of remote UE 705. However, in this first option the CU may not inform DU 715 of the context information of remote UE 705, but instead may manage the establishment and mapping/multiplexing configuration for the channels separately from DU 715. In some aspects, DU 715 may be unaware of remote UE 705 and/or that relay UE 710 is relaying communications between remote UE 705 and the NG RAN.

Generally, UE user plane traffic is sent between the DU 715 and CU-UP 725 based on uplink user plane tunneling information, which may be exchanged for each UE's DRB during the UE context setup messages discussed above. For example, on the E1AP, CU-UP 725 may allocate an uplink tunneling information during the UE bearer context setup procedures and indicate this to the CU-CP 720 for each DRB configured for the UE in the CU-CP 720. The CU-CP 720 includes the uplink user plane tunneling information in the UE context setup messages sent to DU 715 for the corresponding DRB.

To support a single uplink user plane tunneling information association with a relaying RLC channel, CU-CP 720 may setup or otherwise establish bearer context information for the relay UE's relaying RLC channel at CU-UP 725. For example, this may include the relay UE 710 relaying DRB being configured as a “dummy DRB” as the corresponding PDCP/SDAP entities may not be setup on the relay UE or the CU-UP 725. CU-CP 720 may host the remote UEs DRBs mapped to the same relaying Uu RLC channel on same CU-UP 725. One or more relaying RLC channels may be served by the same CU-UP 725. CU-CP 720 may include certain fields in the relay UE E1AP bearer context messages sent to the CU-UP 725 for configuring relaying DRBs for relay UE RLC channels. One example of such a field may include the relaying DRB to setup/modify list including the relaying DRB ID. For example, the CU-UP 725 may include the assigned uplink user plane tunneling information for the relaying DRB in the relay UE E1AP bearer context response messages sent to CU-CP 720. The relaying DRBs success/failure/modified list may include the relaying DRB ID, uplink user plane tunneling information. The CU-CP 720 may include the received relaying DRB uplink user plane tunneling information in the Relay UE F1AP UE context message sent to DU 715. The relaying RLC channel setup/modify list may include the RLC channel ID, the RLC channel QoS, the RLC mode, the uplink user plane tunneling information (e.g., for this relaying RLC channel), and the like. DU 715 may include the downlink user plane tunneling information in the relay UE F1AP UE context response messages sent to CU-CP 720 for each relaying RLC channel. The relaying RLC channel setup/modified list may include the RLC channel ID, the downlink user plane tunneling information, and the like.

Accordingly, the AL implemented at CU (CP and/or UP) may route DRB traffic between DU 715 and the appropriate relaying RLC channel according to the GTP tunneling information associated with each remote UE 705.

FIG. 8A illustrates an example of a CP protocol stack 800-a that supports Uu AL support for layer two relaying in accordance with aspects of the present disclosure. FIG. 8B illustrates an example of a UP protocol stack 800-b that supports Uu adaptation layer support for layer two relaying in accordance with aspects of the present disclosure. CP protocol stack 800-a and UP protocol stack 800-b may implement aspects of wireless communication systems 100, 200, 600, and/or 700, and/or processes 400 and/or 500. Aspects of CP protocol stack 800-a and UP protocol stack 800-b may be implemented at or implemented by a remote UE 805, a relay UE 810, and a NG RAN 815 (e.g., network entity), which may include a DU, a CU-CP, and CU-UP, which may be examples of the corresponding devices described herein. For example, the 5G RAN 815 may generally correspond to a base station (e.g., gNB) and/or network entity (e.g., entity within the 5G RAN), with the base station configured with or otherwise supporting a CU/DU functional split (e.g., within the protocol stack). CP protocol stack 800-a and UP protocol stack 800-b illustrate a non-limiting example of a protocol stack supporting option 2 where the AL is implemented at the DU, and optionally at the CU. In this option 2, the relay UE 810 may be referred to as the first UE while remote UE 805 may be referred to as the second UE, which is the opposite as discussed with reference to option 1.

Generally, each stack or layer with CP protocol stack 800-a and UP protocol stack 800-b may generally correspond to a logical entity/function/mechanism with a wireless network, where each layer communicates with a corresponding layer at a distant end. For example and referring first to the control plane stack, CP protocol stack 800-a may include a NAS layer 820 implemented at remote UE 805 that supports a NAS signaling connection between the UE and an AMF within the core network (e.g., via a N2, NG-C interface between the 5G RAN 815 and 5GC). CP Protocol stack 800-a may include a RRC layer implemented at remote UE 805 as RRC layer 822 communicating with the corresponding RRC layer 840 implemented at CU-CP (e.g., the gNB CU-CP). The RRC layer generally monitors, controls, or otherwise manages aspects of connection establishment and release functions, broadcast of system information, radio bearer establishment, reconfiguration and release, RRC connection mobility procedures, paging, and the like.

CP Protocol stack 800-a may also include a PDCP layer implemented at remote UE 805 at PDCP layer 824 communicating with the corresponding PDCP layer 842 implemented at CU-CP. The PDCP layer in the control plane generally monitors, controls, or otherwise manages aspects of sequence numbering, ciphering/deciphering, integrity protection, etc. CP Protocol stack 800-a may also include an AL implemented at remote UE 805 at AL 826. In this second option, AL 826 may generally communicate with Uu AL 848 of DU. For example, remote UE 805 may include AL 826 communicating with AL 830 of relay UE 810 (e.g., managing aspects of the sidelink, Wi-Fi, Bluetooth, etc., connection between remote UE 805 and relay UE 810). Similarly, relay UE 810 may include a Uu AL 834 communicating with Uu AL 848 of the DU of 5G RAN 815 (e.g. the network entity in this example). The AL generally monitors, controls, or otherwise manages aspects of carrying F1 specific information/routing information, such as backhaul information managing a PTP link.

CP Protocol stack 800-a may also generally include one or more layers supporting the physical link between wireless nodes, such as an RLC layer, MAC layer, PHY layer, etc. The RLC layer generally monitors, controls, or otherwise manages aspects of transfer of upper layer PDUs to the MAC layer through logical channels, sequence numbering, error connection, etc. The MAC layer generally monitors, controls, or otherwise manages aspects of logical-to-transport channel mapping, multiplexing MAC SDUs of logical channels to TB for transmission, and the like. The PHY layer generally monitors, controls, or otherwise manages aspects of modulation/demodulation, coding/decoding, antenna mapping, etc. For example, remote UE 805 may include a RLC/MAC/PHY layer 828 communicating with RLC/MAC/PHY layer 832 of relay UE 810 (e.g., managing aspects of the sidelink, Wi-Fi, Bluetooth, etc., connection between remote UE 805 and relay UE 810). Similarly, relay UE 810 may include a RLC/MAC/PHY layer 836 communicating with RLC/MAC/PHY layer 838 of the DU of 5G RAN 815 (e.g. the network entity in this example). The CU-CP may include a N3 interface 846 managing aspects of the communications between the 5G RAN and a UPF within the 5GC.

Referring next to UP protocol stack 800-b of FIG. 8B, the user plane stack may share many features with the control plane stack (e.g., PDCP, AL, RLC/MAC/PHY layers). These layers may generally perform similar functions as discussed with respect to the control plane stack, but with some changes related to user plane traffic. For example, the PDCP layer in the user plane may manage aspects of header compression/decompression, transfer of user data to lower layers, reordering and duplicate detection, and the like.

The remote UE 805, in the user plane, may include a PDU layer 850 implemented at remote UE 805 that monitors, controls, or otherwise manages aspects of PDU sessions between remote UE 805 and the core network (e.g., 5GC). UP protocol stack 800-b may also include a SDAP layer implemented at remote UE 805 at SDAP layer 852 communicating with the SDAP layer 854 implemented at CU-CP. The SDAP layer generally monitors, controls, or otherwise manages aspects of mapping between QoS flow bearers to DRBs, downlink and uplink packet marking of QFIs, and the like. UP protocol stack 800-b may also include a N2 interface 856 managing aspects of the communications between the 5G RAN and a AMF within the 5GC.

As discussed above with respect to the first solution, aspects of the techniques described therein provide for implementation of AL at the CU (e.g., CU-CP and/or CU-UP) of the network entity. Generally, the AL, alone or in combination with other layers of the network entity, may manage aspects of relaying operations for remote UE 805. For example, the CU may monitor, control, or otherwise manage aspects of determining e2e QoS/slicing configurations of remote UE 805, establishing bearer(s) to support those configurations, and establishment and mapping/multiplexing of channel(s) for the link between remote UE 805 and relay UE 810 as well as for the link between relay UE 810 and DU 815. In some aspects, the CU may establish, when not already present, such channels that support the QoS/slicing configuration of remote UE 805. In that first option the CU may not inform DU of the context information of remote UE 805, but instead may manage the establishment and mapping/multiplexing configuration for the channels separately from DU. In some aspects, the DU may be unaware of remote UE 805 and/or that relay UE 810 is relaying communications between remote UE 805 and the NG RAN 815.

The first solution discussed above (e.g., AL at CU) may result in the DU being only required to manage aspects of the context information of the relay UE 810. However, the first solution also may result in a restriction on the remote UE 805 CU-UP to be the same as the relay UE relaying RLC channel CU-UP. It may be restrictive to host the remote UE bearers on the same CU-UP as the relay UE bearers (e.g., slicing configurations may be different for the relay and remote UEs). Accordingly, aspects of the second solution provide for Uu AL support on the DU, which may address such issues regarding the first solution.

For example, implementation of the AL at the DU (e.g., Uu AL 848 at DU) may support Uu AL and L2 relaying support by the network entity (e.g., a 5G RAN entity, such as a base station including the CU/DU functional split). For example, the relay UE 810 may transmit or otherwise provide a connection setup request message for the remote UE 805. In response, the CU (e.g., CU-CP) may establish context information for the remote UE (e.g., based on the communications between the 5G RAN 815 and the remote UE 805 being via the relay UE 810). This may include CU-CP establishing a local remote UE ID for the remote UE 305 (e.g., an identifier used to distinguish the remote UE 805 during the relayed communications). This may include the DU establishing relaying configuration for the communications with the remote UE 805 via the relay UE 810. This may include association and context for the relay UE 810 and remote UE 805 establishment and maintenance. For example, this may include the association for remote UE(s) connected to the relay UE 810 (e.g., relay UE 810 may support multiple remote UEs), remote UE and relay UE sidelink L2 IDs, remote UE e2e bearers (e.g., SRB1, SRB2, DRB(s)), and the like.

This may include the remote UE traffic multiplexing decision/relaying logical channel ID assignment function being supported either on gNB-CU-CP or gNB-DU. For example, the DU may be made aware of remote UE 805 connected via relay UE 810. One example of the second option may include the Uu AL for SRBs being supported on the CU-CP while another option may include the Uu AL for DRBs being supported on the DU. In this example, the SRBs/control plane context and control plane data handling may be similar to the techniques discussed with respect to the first solution for remote and relay UE control plane. In a second example of the second solution, the Uu AL support for both the SBRs and DRBs may be supported on the DU. The DRBs/user plane data routing may also be considered as part of this second example.

For example, the CU of NG RAN 815 may establish or otherwise maintain UE context information for the relay UE 810 and/or remote UE 805 (e.g., based on the communications between remote UE 805 and NG RAN 815 being via relay UE 810). For example, the CU-CP may allocate the local remote UE ID for remote UE 805. The CU-CP may monitor, control, or otherwise manage aspects of the remote UE 805 and relay UE 810 association and context information. For example, the CU-CP (e.g., Uu AL 844) may manage aspects of the association for the remote UE(s) connected via the relay UE 810, the remote UE and relay UE sidelink L2 IDs, remote UE e2e bearers, and the like. The CU-CP may monitor, control, or otherwise manage aspects of the bearer mapping decisions, such as the N:1 bearer mapping between the remote UE e2e PC5 RLC channel(s) and between the PC5 RLC channel(s) and the Uu RLC channel(s). The CU-CP may monitor, control, or otherwise manage aspects of the relaying configuration (Uu and PC5 RLC channel(s)) management.

The CU-CP may monitor, control, or otherwise manage aspects of the relaying configuration management (e.g., Uu and PC5 RLC channel(s)). The CU-CP may monitor, control, or otherwise manage aspects of the e2e QoS split management for the relaying operations. For example, the CU-CP may determine the QoS split for the Uu RLC channel(s) and the PC5 RLC channel(s) in order to satisfy the e2e QoS for the remote UE SRB(s)/DRB(s) mapped to the RLC channels. In some aspects, Uu AL support for the control plane data at the CU-CP may include AL header support for downlink traffic, routing of uplink AL PDU traffic to the remote UE CU-UP, and the like. The CU-UP may monitor, control, or otherwise manage aspects of the Uu AL support for the user plane data (e.g., AL header management, mapping of AL PDU to the remote UE PDCP layer (e.g., for uplink traffic) or to the RLC channel entity (e.g., for downlink traffic). Accordingly, the CU-CP may manage aspects of establishing the context information for both the remote UE 805 and the relay UE 810.

However, in this second option the DU may monitor, control, or otherwise manage aspects of establishing the relaying configuration for the remote UE 805 (e.g., the second UE in this second solution). For example, the DU (e.g., Uu AL 848) may support relaying Uu RLC channels and provide an indication of the RLC/MAC configuration to the CU-CP. The DU may monitor, control, or otherwise manage aspects of the Uu AL support for the control plane and user plane data, such as AL header support for downlink traffic, routing of uplink AL PDUs to the remote UE CU-UP, and the like. As discussed above, the remote UE bearer multiplexing and relaying (e.g., multiplexing and forwarding) information and/or the relaying configuration for the Uu/PC5 RLC channel ID assignment function may be performed at the CU-CP (e.g., as discussed with reference to the first solution) and/or supported on the DU. Accordingly, the DU may establish the relaying configuration in this second solution and communicate with the remote UE 805 via the relay UE 810 according to the UE context information as well as the relaying configuration.

In some aspects, implementing the Uu AL 848 on the DU may result in the local remote UE ID and remote UE bearer ID(s) used in AL headers being provided to the DU for uplink and downlink traffic. Control plane traffic handling in the downlink example may include CU-CP sending the remote UE RRC message(s) over the relay UE F1Ap context to the DU. The CU-CP may include the local remote UE ID, the remote UE bearer ID, the relaying SRB RLC channel ID(s), as well as other fields in the F1AP downlink RRC message transfer message. The DU may include the received local remote UE ID and the remote UE bearer ID(s) in the Uu AL header and send this information to the remote UE 805 via the relay UE 810.

Control plane traffic in the uplink example may include, upon receiving the RRC messages regarding the relaying DRB RLC channel(s), the DU RLC entity (e.g., RLC layer) passing the packet to the Uu AL 848. The DU may include the local remote UE ID, the remote UE bearer ID, the relaying SRB/DRB RLC channel ID(s), as well as other fields in the F1AP uplink RRC message transfer message. The CU-CP may use the local remote UE ID, the remote UE bearer ID(s), the relaying SRB RLC channel ID(s), as well as other fields in the F1AP message to identify and route to the remote UE SRB PDCP entity.

User plane traffic handling in the downlink example may include CU-CP sending the remote UE DRB downlink traffic to the F1-U tunnel corresponding to the downlink user plane tunneling information configured for the remote UE DRB. The downlink user plane tunneling information may be provided to CU-CP as part of the remote UE bearer information in the F1AP UE context setup response messages. The DU may infer the local remote UE ID and/or the remote UE bearer ID(s) based on the downlink user plane tunneling information association to the remote UE bearer information. The DU may include the local remote UE ID and/or the remote UE bearer ID(s) in the Uu AL header and send data to the remote UE 805 via the relay UE 810.

User plane traffic in the uplink example may include, upon receiving the remote UE DRB uplink traffic on the relaying DRB RLC channel(s), the DU RLC entity may pass the packet to the Uu AL entity. The DU may infer the uplink user plane tunneling information associated with the remote UE bearer based on the local remote UE ID, the remote UE bearer ID(s), and/or the association to the remote UE bearer information. the CU-UP may use the uplink user plane tunnel that data is received to identify and route to the remote UE DRB PDCP entity.

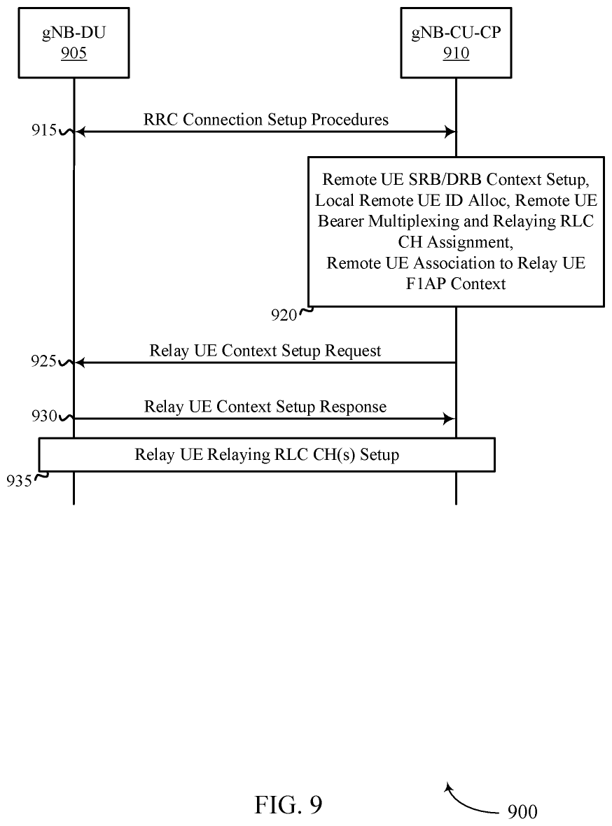

FIG. 9 illustrates an example of a process 900 that supports Uu AL support for layer two relaying in accordance with aspects of the present disclosure. process 900 may implement aspects of wireless communication systems 100, 200. 600 and/or 700, protocol stacks 300, 800-a, and/or 800-b, and/or processes 400 and/or 500. Aspects of process 900 may be implemented at or implemented by a DU 905 (e.g., gNB-DU) and a CU-CP 910 (e.g., gNB-CU-CP), which may be examples of the corresponding devices described herein. For example, DU 905 and CU-CP 910 may be associated with a network entity, such as a base station/entity within a NG RAN supporting a CU/DU functional split. Process 900 generally illustrates a non-limiting example of L2 relaying support according to a second option where the AL functionality is configured for or otherwise supported by DU 905. Process 900 generally illustrates an example where the multiplexing decision is performed by the gNB-CU-CP.

For example, this second option may include DU 905 establishing the relaying configuration for the remote UE (e.g., a second UE in this second solution) connecting via a relay UE (e.g., a first UE in this second solution).

At 915, this may include the CP-CU 910 performing RRC connection setup procedures. For example, the CU-CP 910 may receive a connection setup request message for the remote UE (e.g., a RRC connection setup request message for the remote UE from the relay UE via DU 905).

In response, the CU-CP 910 may establish UE context information for the remote UE and/or relay UE at 920. For example, the CU-CP may allocate the local remote UE ID, setup the SRB/DRB context for the remote UE, establish the remote UE bearer multiplexing and relaying RLC channel assignments, associate the remote UE to the relay UE in the F1AP context, and the like. Accordingly, the CU-CP 910 may assign the relaying RLC channel ID(s) for the remote UE SRB(s) and/or DRB(s) as well as setup the relay UE context with the DU 905.

For example, at 925 CU-CP 910 may transmit or otherwise provide (and DU 905 may receive or otherwise obtain) a relay UE context setup request message. The message may generally carry or otherwise convey an indication of bearer information for the remote UE, such as a remote UE ID, bearer ID(s), uplink user plane tunneling information, and the like. For example, the CU-CP 910 may transmit or otherwise provide a relay UE F1AP context setup request/modify message to DU 905 carrying or otherwise conveying various information. For example, the message may include a relaying SRB RLC channel list, which includes the RLC channel ID(s). The message may include a relaying DRB RLC channel list, which includes the RLC channel ID(s), the RLC channel QoS information, the RLC mode, and/or the remote UE bearer information. The remote UE bearer information may include a remote UE ID (e.g., the local remote UE ID), the remote UE bearer ID(s), the uplink user plane tunneling information, the Uu RLC channel mapping information used at/by DU 905 to route traffic, and the like. In some examples, the message may include a sidelink DRB setup list, which may include the sidelink DRB ID(s), the sidelink QoS information (which may be based on the split between the remote UE e2e QoS between the Uu RLC channel and the PC5 RLC channel), and the like.

At 930, DU 905 may transmit or otherwise provide (and CU-CP 910 may receive or otherwise obtain) a relay UE context setup response message. Generally, the message may carry or otherwise convey an indication of a result of DU 905 establishing remote UE bearers. For example, the message may include an F1AP UE context setup response/UE context modification response/UE context modification required message sent for the relay UE context. DU 905 may include in the message a relaying SRB RLC channel setup/modification list, including the RLC channel ID(s), a relaying DRB RLC channel setup/modification list, including the RLC channel ID(s) and a remote UE bearer information. The remote UE bearer information may include the remote UE identifier, the remote UE DRB ID(s), the downlink user plane tunneling information, and the like. The message may include a relaying SRB/DRB RLC channel failed list, including the RLC channel ID(s).

Accordingly, at 935 DU 905 and CU-CP 910 may setup or otherwise establish the relay UE relaying RLC channel(s) according to the techniques discussed herein. The RLC channel(s) may be mapped to the remote UE bearers according to such techniques and used to perform relayed communications. For example, the remote UE may communicate with the NG RAN via the relay UE according to the UE context information and the relaying configuration.

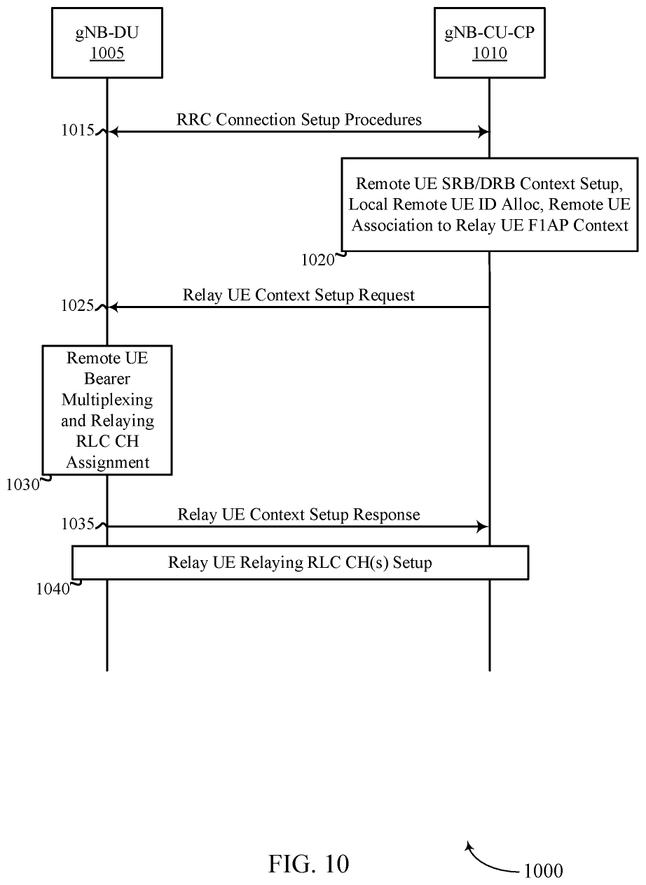

FIG. 10 illustrates an example of a process 1000 that supports Uu AL support for layer two relaying in accordance with aspects of the present disclosure. Process 1000 may implement aspects of wireless communication systems 100, 200, 600 and/or 700, protocol stacks 300, 800-a, and/or 800-b, and/or processes 400, 500 and/or 900. Aspects of process 1000 may be implemented at or implemented by a DU 1005 (e.g., gNB-DU) and a CU-CP 1010 (e.g., gNB-CU-CP), which may be examples of the corresponding devices described herein. For example, DU 1005 and CU-CP 1010 may be associated with a network entity, such as a base station/entity within a NG RAN supporting a CU/DU functional split. Process 1000 generally illustrates a non-limiting example of L2 relaying support according to a second option where the AL functionality is configured for or otherwise supported by DU 1005. Process 1000 generally illustrates an example where the multiplexing decision is performed by the gNB-DU.

For example, this second option may include DU 1005 establishing the relaying configuration for the remote UE (e.g., a second UE in this second solution) connecting via a relay UE (e.g., a first UE in this second solution).

At 1015, this may include the CP-CU 1010 performing RRC connection setup procedures. For example, the CU-CP 1010 may receive a connection setup request message for the remote UE (e.g., a RRC connection setup request message for the remote UE from the relay UE via DU 1005).

In response, the CU-CP 1010 may establish UE context information for the remote UE and/or relay UE at 1020. For example, the CU-CP may allocate the local remote UE ID, setup the SRB/DRB context for the remote UE, associate the remote UE to the relay UE in the F1AP context, and the like. However, in the example illustrated in process 1000, the DU 1005 may generally assign the RLC channel ID(s) for the remote UE SRB(s)/DRB(s).

For example, at 1025 CU-CP 1010 may transmit or otherwise provide (and DU 1005 may receive or otherwise obtain) a relay UE context setup request message. For example, the CU-CP 1010 may transmit or otherwise provide a relay UE F1AP context setup request/modify message to DU 1005 carrying or otherwise conveying various information. For example, the message may include a relaying SRB RLC channel to be setup list, which includes the remote UE bearer information such as the remote UE ID and remote UE SRB ID. The message may include a relaying DRB RLC channel to be setup list, which includes the remote UE bearer information such as the remote UE ID, the remote UE DRB ID(s), RLC channel QoS, RLC mode, uplink user plane tunneling information, and the like. The message may include a sidelink DRB setup list, which includes the sidelink DRB ID(s), the sidelink QoS (e.g., considering the split of the remote UE e2e QoS between the Uu RLC channel(s) and the PC5 RLC channel(s)), and the like.

At 1030, the DU 1005 may generally establish the relaying configuration for the remote UE, which generally defines the multiplexing and forwarding information for the Uu connection between the relay UE and DU 1005 and/or the PC5 (or other) connection between the remote UE and the relay UE. For example, the AL implemented at DU 1005 may generally establish the relaying configuration for the remote UE and the relay UE.

At 1035, DU 1005 may transmit or otherwise provide (and CU-CP 1010 may receive or otherwise obtain) a relay UE context setup response message. Generally, the message may carry or otherwise convey an indication of a result of DU 1005 establishing remote UE bearers. For example, the message may include an F1AP UE context setup response/UE context modification response/UE context modification required message sent for the relay UE context. The message may include information regarding the assigned relaying RLC channel(s) for the remote UE bearer(s). DU 1005 may include in the message a relaying SRB RLC channel setup/modification list, including the remote UE bearer information such as the remote UE ID, the remote UE SRB ID(s), the RLC channel ID(s), and the like. The message may include a relaying DRB RLC channel setup/modification list, including the remote UE bearer information such as the remote UE ID, the remote UE DRB ID(s), the RLC channel ID(s) the downlink user plane tunneling information, and the like. The message may include a relaying SRB/DRB RLC channel failed list, including the RLC channel ID(s) (e.g., for the channels that were unable to be established).

Accordingly, at 1040 DU 1005 and CU-CP 1010 may setup or otherwise establish the relay UE relaying RLC channel(s) according to the techniques discussed herein. The RLC channel(s) may be mapped to the remote UE bearers according to such techniques and used to perform relayed communications. For example, the remote UE may communicate with the NG RAN via the relay UE according to the UE context information and the relaying configuration.

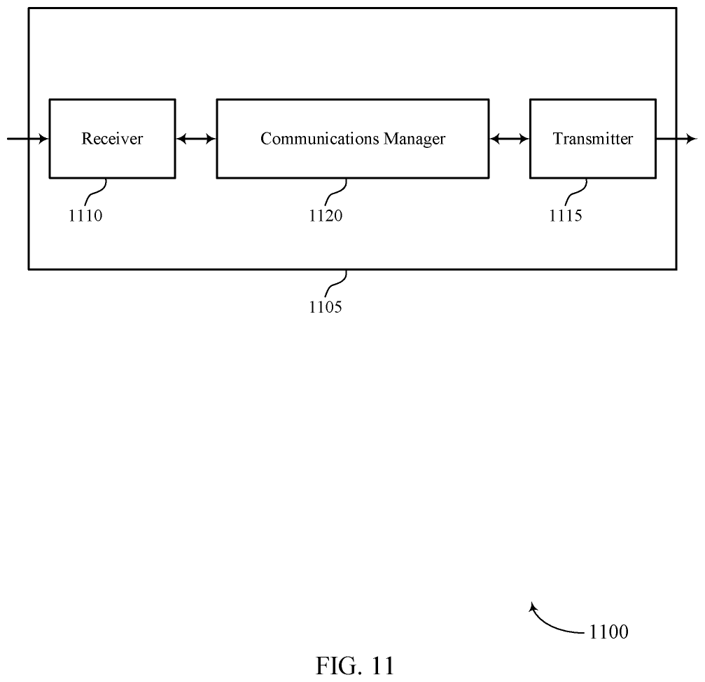

FIG. 11 shows a block diagram 1100 of a device 1105 that supports Uu AL support for layer two relaying in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to Uu AL support for layer two relaying). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to Uu AL support for layer two relaying). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of Uu AL support for layer two relaying as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a CU of a network entity in accordance with examples as disclosed herein. For example, the communications manager 1120 may be configured as or otherwise support a means for receiving, from a first UE via a second UE, a connection setup request message for a first UE. The communications manager 1120 may be configured as or otherwise support a means for establishing UE context information for the first UE at an AL of the CU, the UE context information based on communications between the first UE and the network entity via the second UE. The communications manager 1120 may be configured as or otherwise support a means for transmitting, to one or more DUs associated with the CU, an indication of a relaying configuration for the first UE connecting to the network entity via the second UE, the relaying configuration including multiplexing and forwarding information for a connection between the second UE and each DU of the one or more DUs. The communications manager 1120 may be configured as or otherwise support a means for communicating with the first UE via the second UE according to the UE context information and the relaying configuration.

Additionally or alternatively, the communications manager 1120 may support wireless communication at a DU of a network entity in accordance with examples as disclosed herein. For example, the communications manager 1120 may be configured as or otherwise support a means for receiving, from a CU of the network entity, an indication of a relaying configuration for a first UE connecting to the network entity via a second UE. The communications manager 1120 may be configured as or otherwise support a means for determining, based on the relaying configuration, multiplexing and forwarding information for the connection between the second UE and the DU. The communications manager 1120 may be configured as or otherwise support a means for relaying communications between the first UE and the network entity via the second UE according to the multiplexing and forwarding information.

Additionally or alternatively, the communications manager 1120 may support wireless communication at a DU of a network entity in accordance with examples as disclosed herein. For example, the communications manager 1120 may be configured as or otherwise support a means for obtaining, from a CU of the network entity, a context setup request message for a first UE. The communications manager 1120 may be configured as or otherwise support a means for establishing UE context information for the first UE at the CU, the UE context information based on communications between a second UE and the network entity via the first UE. The communications manager 1120 may be configured as or otherwise support a means for establishing, at an adaptation layer of the DU, a relaying configuration for the second UE connecting to the network entity via the first UE, the relaying configuration including multiplexing and forwarding information for a connection between the first UE and the DU. The communications manager 1120 may be configured as or otherwise support a means for communicating with the second UE via the first UE according to the UE context information and the relaying configuration.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for implementation of the AL functionality at the CU and/or the DU in an entity within the NG RAN supporting a CU/DU functional split.

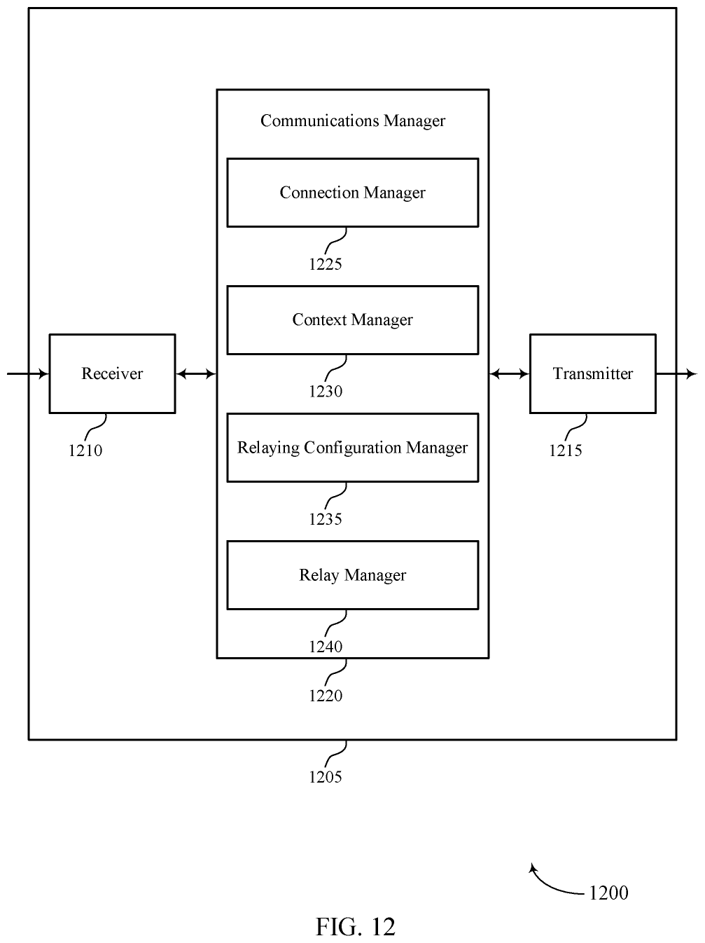

FIG. 12 shows a block diagram 1200 of a device 1205 that supports Uu AL support for layer two relaying in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to Uu AL support for layer two relaying). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to Uu AL support for layer two relaying). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of Uu AL support for layer two relaying as described herein. For example, the communications manager 1220 may include a connection manager 1225, a context manager 1230, a relaying configuration manager 1235, a relay manager 1240, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a CU of a network entity in accordance with examples as disclosed herein. The connection manager 1225 may be configured as or otherwise support a means for receiving, from a first UE via a second UE, a connection setup request message for a first UE. The context manager 1230 may be configured as or otherwise support a means for establishing UE context information for the first UE at an AL of the CU, the UE context information based on communications between the first UE and the network entity via the second UE. The relaying configuration manager 1235 may be configured as or otherwise support a means for transmitting, to one or more DUs associated with the CU, an indication of a relaying configuration for the first UE connecting to the network entity via the second UE, the relaying configuration including multiplexing and forwarding information for a connection between the second UE and each DU of the one or more DUs. The relay manager 1240 may be configured as or otherwise support a means for communicating with the first UE via the second UE according to the UE context information and the relaying configuration.

Additionally or alternatively, the communications manager 1220 may support wireless communication at a DU of a network entity in accordance with examples as disclosed herein. The relaying configuration manager 1235 may be configured as or otherwise support a means for receiving, from a CU of the network entity, an indication of a relaying configuration for a first UE connecting to the network entity via a second UE. The relay manager 1240 may be configured as or otherwise support a means for determining, based on the relaying configuration, multiplexing and forwarding information for the connection between the second UE and the DU. The relay manager 1240 may be configured as or otherwise support a means for relaying communications between the first UE and the network entity via the second UE according to the multiplexing and forwarding information.

Additionally or alternatively, the communications manager 1220 may support wireless communication at a DU of a network entity in accordance with examples as disclosed herein. The context manager 1230 may be configured as or otherwise support a means for obtaining, from a CU of the network entity, a context setup request message for a first UE. The context manager 1230 may be configured as or otherwise support a means for establishing UE context information for the first UE at the CU, the UE context information based on communications between a second UE and the network entity via the first UE. The relaying configuration manager 1235 may be configured as or otherwise support a means for establishing, at an adaptation layer of the DU, a relaying configuration for the second UE connecting to the network entity via the first UE, the relaying configuration including multiplexing and forwarding information for a connection between the first UE and the DU. The relay manager 1240 may be configured as or otherwise support a means for communicating with the second UE via the first UE according to the UE context information and the relaying configuration.

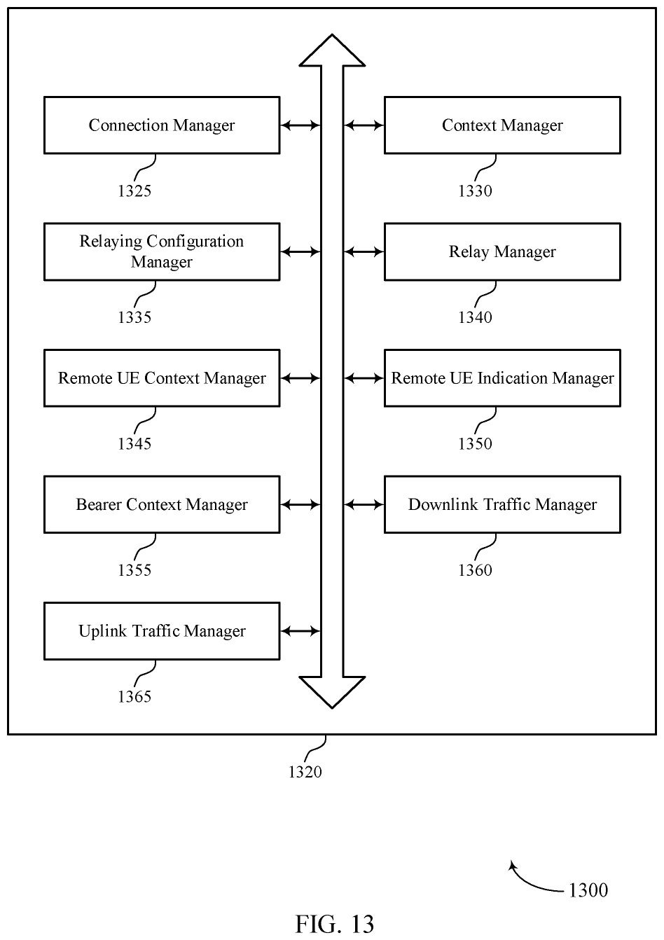

FIG. 13 shows a block diagram 1300 of a communications manager 1320 that supports Uu AL support for layer two relaying in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of Uu AL support for layer two relaying as described herein. For example, the communications manager 1320 may include a connection manager 1325, a context manager 1330, a relaying configuration manager 1335, a relay manager 1340, a remote UE context manager 1345, a remote UE indication manager 1350, a bearer context manager 1355, a downlink traffic manager 1360, an uplink traffic manager 1365, or any combination thereof. Each of these components may communicate, directly or indirectly, with one another (e.g., via one or more buses).

The communications manager 1320 may support wireless communication at a CU of a network entity in accordance with examples as disclosed herein. The connection manager 1325 may be configured as or otherwise support a means for receiving, from a first UE via a second UE, a connection setup request message for a first UE. The context manager 1330 may be configured as or otherwise support a means for establishing UE context information for the first UE at an AL of the CU, the UE context information based on communications between the first UE and the network entity via the second UE. The relaying configuration manager 1335 may be configured as or otherwise support a means for transmitting, to one or more DUs associated with the CU, an indication of a relaying configuration for the first UE connecting to the network entity via the second UE, the relaying configuration including multiplexing and forwarding information for a connection between the second UE and each DU of the one or more DUs. The relay manager 1340 may be configured as or otherwise support a means for communicating with the first UE via the second UE according to the UE context information and the relaying configuration.

In some examples, to support establishing the UE context information for the first UE, the remote UE context manager 1345 may be configured as or otherwise support a means for allocating, at a control plane of the CU, a remote UE identifier to the first UE. In some examples, to support establishing the UE context information for the first UE, the remote UE context manager 1345 may be configured as or otherwise support a means for establishing association and context information for the first UE and the second UE, the association and context information including an association between the remote UE identifier and the first UE, one or more bearers for the first UE, or both. In some examples, to support establishing the UE context information for the first UE, the remote UE context manager 1345 may be configured as or otherwise support a means for establishing multiplexing information for the one or more bearers of the first UE, the multiplexing information including a first mapping between the one or more bearers of the first UE to one or more sidelink channels between the first UE and the second UE and a second mapping between the sidelink channel to one or more cellular channels of the second UE. In some examples, to support establishing the UE context information for the first UE, the remote UE context manager 1345 may be configured as or otherwise support a means for assigning, based on the multiplexing information, channel identifiers to the one or more sidelink channels and to the one or more cellular channels.

In some examples, the remote UE context manager 1345 may be configured as or otherwise support a means for transmitting the indication of the context information to the first UE and to the second UE.

In some examples, the remote UE context manager 1345 may be configured as or otherwise support a means for determining an end-to-end quality of service for the one or more bearers of the first UE. In some examples, the remote UE context manager 1345 may be configured as or otherwise support a means for establishing a sidelink quality of service parameter for each of the one or more sidelink channels and the one or more cellular channels based on the end-to-end quality of service.

In some examples, the remote UE context manager 1345 may be configured as or otherwise support a means for determining a slicing configuration for the one or more bearers of the first UE, where the relaying configuration is based on the slicing configuration.

In some examples, the remote UE context manager 1345 may be configured as or otherwise support a means for determining, at the control plane of the CU, at a user plane of the CU, or both, an AL PDU mapping for the first UE, the PDU mapping including a PDU-to-PDCP mapping of the first UE, a PDU-to-channel mapping for the one or more cellular channels, or both.

In some examples, the remote UE indication manager 1350 may be configured as or otherwise support a means for transmitting, from a control plane of the CU to a user plane of the CU, an indication of a remote UE identifier for the first UE. In some examples, the remote UE indication manager 1350 may be configured as or otherwise support a means for transmitting, to the one or more DUs, an indication of one or more relay cellular channels associated with the first UE.

In some examples, the bearer context manager 1355 may be configured as or otherwise support a means for transmitting, from a control plane of the CU to a user plane of the CU, a bearer context message for the first UE indicating uplink user plane tunneling information mapping a radio link control channel between the second UE and the DU to a bearer associated with the first UE, where the mapping is based on a local remote UE identifier associated with the first UE.

In some examples, the bearer context manager 1355 may be configured as or otherwise support a means for transmitting, from a control plane of the CU to a user plane of the CU, a bearer context message for the first UE indicating downlink user plane tunneling information mapping a radio link control channel between the second UE and the DU to a bearer associated with the first UE. In some aspects, the SRBs and DRBs are managed at the DU of the network entity or the SRBs are managed at the CU of the network entity with the DRBs being managed at the DU of the network entity.

Additionally or alternatively, the communications manager 1320 may support wireless communication at a DU of a network entity in accordance with examples as disclosed herein. In some examples, the relaying configuration manager 1335 may be configured as or otherwise support a means for receiving, from a CU of the network entity, an indication of a relaying configuration for a first UE connecting to the network entity via a second UE. In some examples, the relay manager 1340 may be configured as or otherwise support a means for determining, based on the relaying configuration, multiplexing and forwarding information for the connection between the second UE and the DU. In some examples, the relay manager 1340 may be configured as or otherwise support a means for relaying communications between the first UE and the network entity via the second UE according to the multiplexing and forwarding information.

In some examples, the relaying configuration manager 1335 may be configured as or otherwise support a means for receiving, from the CU of the network entity, an indication of a relay channel configuration associated with the first UE. In some examples, the relaying configuration manager 1335 may be configured as or otherwise support a means for establishing one or more relay cellular channels with the second UE based on the relay channel configuration.

Additionally or alternatively, the communications manager 1320 may support wireless communication at a DU of a network entity in accordance with examples as disclosed herein. In some examples, the context manager 1330 may be configured as or otherwise support a means for obtaining, from a CU of the network entity, a context setup request message for a first UE. In some examples, the context manager 1330 may be configured as or otherwise support a means for establishing UE context information for the first UE at the CU, the UE context information based on communications between a second UE and the network entity via the first UE. In some examples, the relaying configuration manager 1335 may be configured as or otherwise support a means for establishing, at an adaptation layer of the DU, a relaying configuration for the second UE connecting to the network entity via the first UE, the relaying configuration including multiplexing and forwarding information for a connection between the first UE and the DU. In some examples, the relay manager 1340 may be configured as or otherwise support a means for communicating with the second UE via the first UE according to the UE context information and the relaying configuration.

In some examples, the context manager 1330 may be configured as or otherwise support a means for receiving, from the CU, a UE context setup request message indicating remote UE bearer information associated with the second UE, the remote UE bearer information including a remote UE identifier, one or more bearer identifiers, mapping of a radio link control channel between the first UE and the DU, uplink user plane tunneling information, or any combination thereof for the second UE.

In some examples, the context manager 1330 may be configured as or otherwise support a means for transmitting, to the CU, a UE context setup response message indicating a result of establishing remote UE bearers associated with the first UE, the UE context setup response message including at least one of a remote UE identifier, one or more bearer identifiers, downlink user plane tunneling information, or any combination thereof for the first UE.

In some examples, the bearer context manager 1355 may be configured as or otherwise support a means for establishing association and context information for the first UE and the second UE, the association and context information including an association between a remote UE identifier and the first UE, one or more bearers for the first UE, or both. In some examples, the bearer context manager 1355 may be configured as or otherwise support a means for establishing multiplexing information for the one or more bearers of the first UE, the multiplexing information including a first mapping between the one or more bearers of the first UE to one or more sidelink channels between the first UE and the second UE and a second mapping between the sidelink channel to one or more cellular channels of the second UE. In some examples, the bearer context manager 1355 may be configured as or otherwise support a means for assigning, based on the multiplexing information, channel identifiers to the one or more sidelink channels and to the one or more cellular channels.

In some examples, the downlink traffic manager 1360 may be configured as or otherwise support a means for receiving, from a control plane of the CU, an indication of downlink traffic for the first UE, the indication including a remote UE identifier associated with the first UE, a remote UE bearer identifier, a relay cellular channel identifier, or any combination thereof. In some examples, the downlink traffic manager 1360 may be configured as or otherwise support a means for transmitting the downlink traffic to the first UE for forwarding to the second UE according to the indication.

In some examples, the uplink traffic manager 1365 may be configured as or otherwise support a means for receiving, from the first UE, an indication of uplink traffic from the second UE, the indication including a remote UE identifier associated with the first UE, a remote UE bearer identifier, a relay cellular channel identifier, or any combination thereof. In some examples, the uplink traffic manager 1365 may be configured as or otherwise support a means for transmitting the uplink traffic to a control plane of the UE for forwarding to a destination address associated with the uplink traffic.

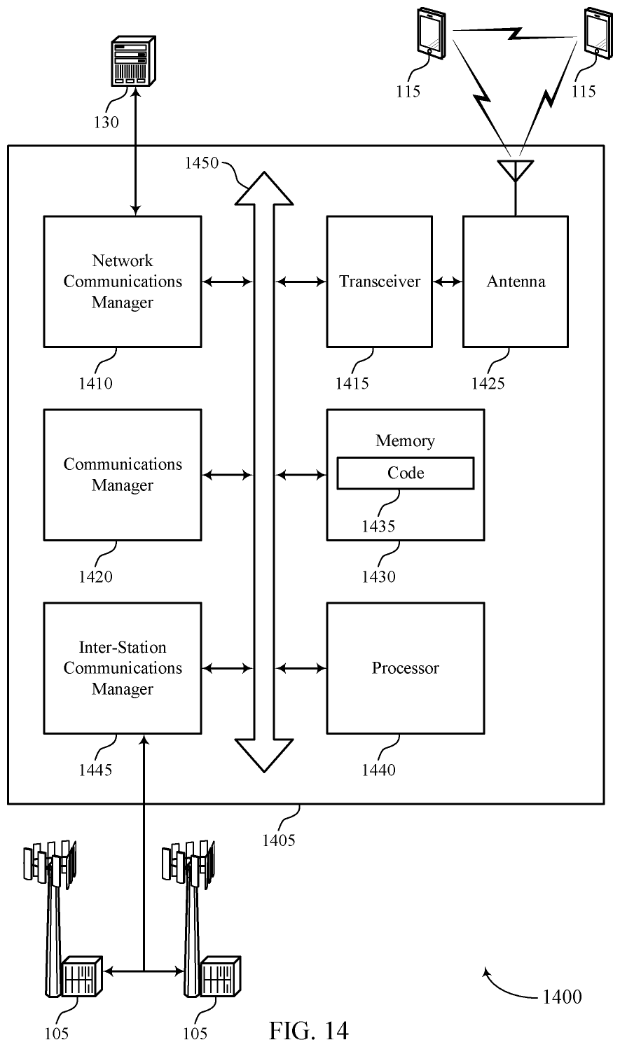

FIG. 14 shows a diagram of a system 1400 including a device 1405 that supports Uu AL support for layer two relaying in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting Uu AL support for layer two relaying). For example, the device 1405 or a component of the device 1405 may include a processor 1440 and memory 1430 coupled with or to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a CU of a network entity in accordance with examples as disclosed herein. For example, the communications manager 1420 may be configured as or otherwise support a means for receiving, from a first UE via a second UE, a connection setup request message for a first UE. The communications manager 1420 may be configured as or otherwise support a means for establishing UE context information for the first UE at an AL of the CU, the UE context information based on communications between the first UE and the network entity via the second UE. The communications manager 1420 may be configured as or otherwise support a means for transmitting, to one or more distributed units (DUs) associated with the CU, an indication of a relaying configuration for the first UE connecting to the network entity via the second UE, the relaying configuration including multiplexing and forwarding information for a connection between the second UE and each DU of the one or more DUs. The communications manager 1420 may be configured as or otherwise support a means for communicating with the first UE via the second UE according to the UE context information and the relaying configuration.

Additionally or alternatively, the communications manager 1420 may support wireless communication at a DU of a network entity in accordance with examples as disclosed herein. For example, the communications manager 1420 may be configured as or otherwise support a means for receiving, from a CU of the network entity, an indication of a relaying configuration for a first UE connecting to the network entity via a second UE. The communications manager 1420 may be configured as or otherwise support a means for determining, based on the relaying configuration, multiplexing and forwarding information for the connection between the second UE and the DU. The communications manager 1420 may be configured as or otherwise support a means for relaying communications between the first UE and the network entity via the second UE according to the multiplexing and forwarding information.

Additionally or alternatively, the communications manager 1420 may support wireless communication at a DU of a network entity in accordance with examples as disclosed herein. For example, the communications manager 1420 may be configured as or otherwise support a means for obtaining, from a CU of the network entity, a context setup request message for a first UE. The communications manager 1420 may be configured as or otherwise support a means for establishing UE context information for the first UE at the CU, the UE context information based on communications between a second UE and the network entity via the first UE. The communications manager 1420 may be configured as or otherwise support a means for establishing, at an adaptation layer of the DU, a relaying configuration for the second UE connecting to the network entity via the first UE, the relaying configuration including multiplexing and forwarding information for a connection between the first UE and the DU. The communications manager 1420 may be configured as or otherwise support a means for communicating with the second UE via the first UE according to the UE context information and the relaying configuration.

By including or configuring the communications manager 1420 in accordance with examples as described herein, the device 1405 may support techniques for implementation of the AL functionality at the CU and/or the DU in an entity within the NG RAN supporting a CU/DU functional split.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of Uu AL support for layer two relaying as described herein, or the processor 1440 and the memory 1430 may be otherwise configured to perform or support such operations.

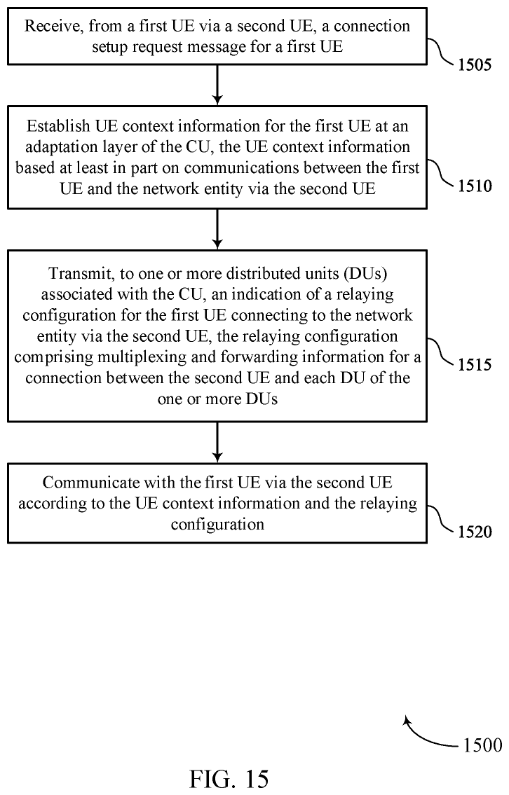

FIG. 15 shows a flowchart illustrating a method 1500 that supports Uu AL support for layer two relaying in accordance with aspects of the present disclosure. The operations of the method 1500 may be implemented by a base station or its components as described herein. For example, the operations of the method 1500 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 1505, the method may include receiving, from a first UE via a second UE, a connection setup request message for a first UE. The operations of 1505 may be performed in accordance with examples as disclosed herein. In some examples, aspects of the operations of 1505 may be performed by a connection manager 1325 as described with reference to FIG. 13.

At 1510, the method may include establishing UE context information for the first UE at an AL of the CU, the UE context information based on communications between the first UE and the network entity via the second UE. The operations of 1510 may be performed in accordance with examples as disclosed herein. In some examples, aspects of the operations of 1510 may be performed by a context manager 1330 as described with reference to FIG. 13.

At 1515, the method may include transmitting, to one or more DUs associated with the CU, an indication of a relaying configuration for the first UE connecting to the network entity via the second UE, the relaying configuration including multiplexing and forwarding information for a connection between the second UE and each DU of the one or more DUs. The operations of 1515 may be performed in accordance with examples as disclosed herein. In some examples, aspects of the operations of 1515 may be performed by a relaying configuration manager 1335 as described with reference to FIG. 13.

At 1520, the method may include communicating with the first UE via the second UE according to the UE context information and the relaying configuration. The operations of 1520 may be performed in accordance with examples as disclosed herein. In some examples, aspects of the operations of 1520 may be performed by a relay manager 1340 as described with reference to FIG. 13.

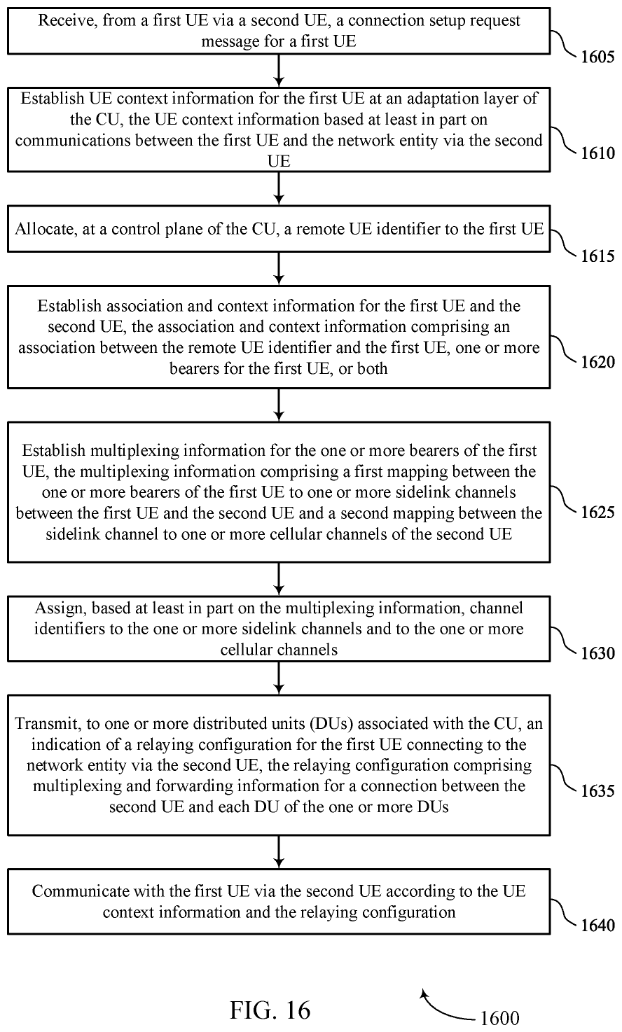

FIG. 16 shows a flowchart illustrating a method 1600 that supports Uu AL support for layer two relaying in accordance with aspects of the present disclosure. The operations of the method 1600 may be implemented by a base station or its components as described herein. For example, the operations of the method 1600 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 1605, the method may include receiving, from a first UE via a second UE, a connection setup request message for a first UE. The operations of 1605 may be performed in accordance with examples as disclosed herein. In some examples, aspects of the operations of 1605 may be performed by a connection manager 1325 as described with reference to FIG. 13.

At 1610, the method may include establishing UE context information for the first UE at an AL of the CU, the UE context information based on communications between the first UE and the network entity via the second UE. The operations of 1610 may be performed in accordance with examples as disclosed herein. In some examples, aspects of the operations of 1610 may be performed by a context manager 1330 as described with reference to FIG. 13.

At 1615, the method may include allocating, at a control plane of the CU, a remote UE identifier to the first UE. The operations of 1615 may be performed in accordance with examples as disclosed herein. In some examples, aspects of the operations of 1615 may be performed by a remote UE context manager 1345 as described with reference to FIG. 13.

At 1620, the method may include establishing association and context information for the first UE and the second UE, the association and context information including an association between the remote UE identifier and the first UE, one or more bearers for the first UE, or both. The operations of 1620 may be performed in accordance with examples as disclosed herein. In some examples, aspects of the operations of 1620 may be performed by a remote UE context manager 1345 as described with reference to FIG. 13.

At 1625, the method may include establishing multiplexing information for the one or more bearers of the first UE, the multiplexing information including a first mapping between the one or more bearers of the first UE to one or more sidelink channels between the first UE and the second UE and a second mapping between the sidelink channel to one or more cellular channels of the second UE. The operations of 1625 may be performed in accordance with examples as disclosed herein. In some examples, aspects of the operations of 1625 may be performed by a remote UE context manager 1345 as described with reference to FIG. 13.

At 1630, the method may include assigning, based on the multiplexing information, channel identifiers to the one or more sidelink channels and to the one or more cellular channels. The operations of 1630 may be performed in accordance with examples as disclosed herein. In some examples, aspects of the operations of 1630 may be performed by a remote UE context manager 1345 as described with reference to FIG. 13.

At 1635, the method may include transmitting, to one or more DUs associated with the CU, an indication of a relaying configuration for the first UE connecting to the network entity via the second UE, the relaying configuration including multiplexing and forwarding information for a connection between the second UE and each DU of the one or more DUs. The operations of 1635 may be performed in accordance with examples as disclosed herein. In some examples, aspects of the operations of 1635 may be performed by a relaying configuration manager 1335 as described with reference to FIG. 13.

At 1640, the method may include communicating with the first UE via the second UE according to the UE context information and the relaying configuration. The operations of 1640 may be performed in accordance with examples as disclosed herein. In some examples, aspects of the operations of 1640 may be performed by a relay manager 1340 as described with reference to FIG. 13.

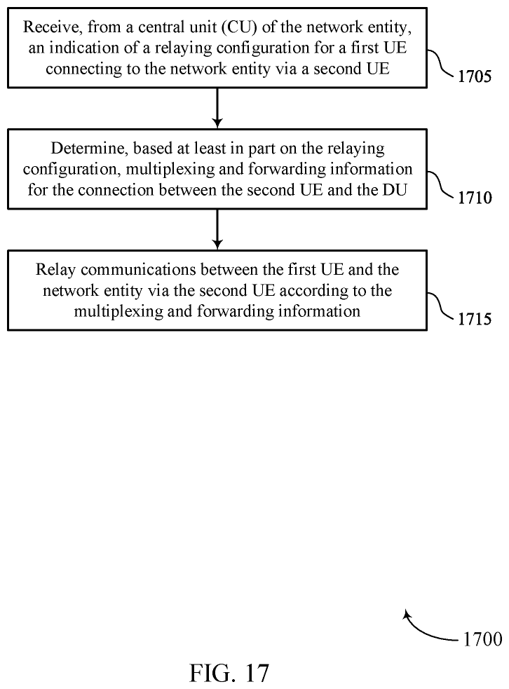

FIG. 17 shows a flowchart illustrating a method 1700 that supports Uu AL support for layer two relaying in accordance with aspects of the present disclosure. The operations of the method 1700 may be implemented by a base station or its components as described herein. For example, the operations of the method 1700 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 1705, the method may include receiving, from a CU of the network entity, an indication of a relaying configuration for a first UE connecting to the network entity via a second UE. The operations of 1705 may be performed in accordance with examples as disclosed herein. In some examples, aspects of the operations of 1705 may be performed by a relaying configuration manager 1335 as described with reference to FIG. 13.

At 1710, the method may include determining, based on the relaying configuration, multiplexing and forwarding information for the connection between the second UE and the DU. The operations of 1710 may be performed in accordance with examples as disclosed herein. In some examples, aspects of the operations of 1710 may be performed by a relay manager 1340 as described with reference to FIG. 13.

At 1715, the method may include relaying communications between the first UE and the network entity via the second UE according to the multiplexing and forwarding information. The operations of 1715 may be performed in accordance with examples as disclosed herein. In some examples, aspects of the operations of 1715 may be performed by a relay manager 1340 as described with reference to FIG. 13.

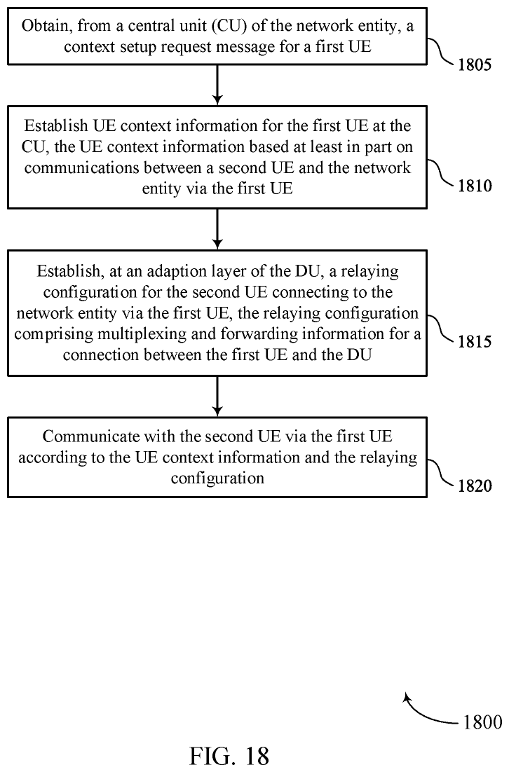

FIG. 18 shows a flowchart illustrating a method 1800 that supports Uu AL support for layer two relaying in accordance with aspects of the present disclosure. The operations of the method 1800 may be implemented by a base station or its components as described herein. For example, the operations of the method 1800 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 1805, the method may include obtaining, from a CU of the network entity, a context setup request message for a first UE. The operations of 1805 may be performed in accordance with examples as disclosed herein. In some examples, aspects of the operations of 1805 may be performed by a context manager 1330 as described with reference to FIG. 13.

At 1810, the method may include establishing UE context information for the first UE at the CU, the UE context information based on communications between a second UE and the network entity via the first UE. The operations of 1810 may be performed in accordance with examples as disclosed herein. In some examples, aspects of the operations of 1810 may be performed by a context manager 1330 as described with reference to FIG. 13.

At 1815, the method may include establishing, at an adaptation layer of the DU, a relaying configuration for the second UE connecting to the network entity via the first UE, the relaying configuration including multiplexing and forwarding information for a connection between the first UE and the DU. The operations of 1815 may be performed in accordance with examples as disclosed herein. In some examples, aspects of the operations of 1815 may be performed by a relaying configuration manager 1335 as described with reference to FIG. 13.

At 1820, the method may include communicating with the second UE via the first UE according to the UE context information and the relaying configuration. The operations of 1820 may be performed in accordance with examples as disclosed herein. In some examples, aspects of the operations of 1820 may be performed by a relay manager 1340 as described with reference to FIG. 13.

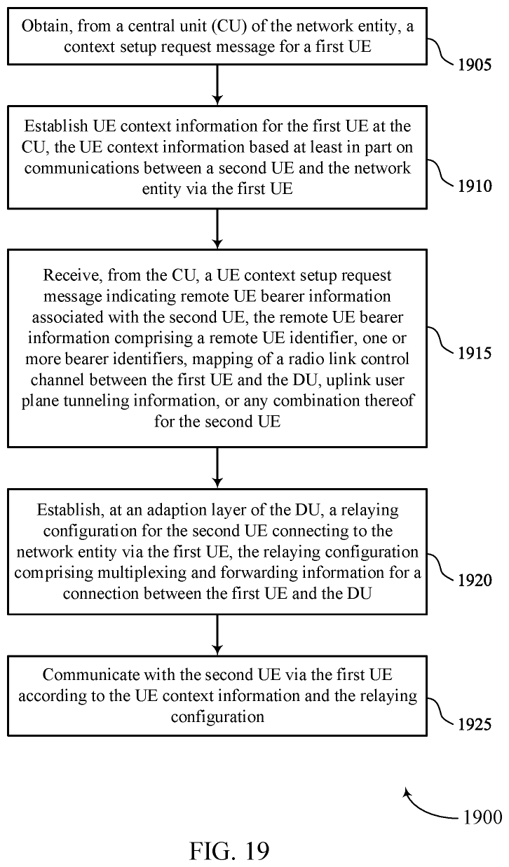

FIG. 19 shows a flowchart illustrating a method 1900 that supports Uu AL support for layer two relaying in accordance with aspects of the present disclosure. The operations of the method 1900 may be implemented by a base station or its components as described herein. For example, the operations of the method 1900 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 1905, the method may include obtaining, from a CU of the network entity, a context setup request message for a first UE. The operations of 1905 may be performed in accordance with examples as disclosed herein. In some examples, aspects of the operations of 1905 may be performed by a context manager 1330 as described with reference to FIG. 13.

At 1910, the method may include establishing UE context information for the first UE at the CU, the UE context information based on communications between a second UE and the network entity via the first UE. The operations of 1910 may be performed in accordance with examples as disclosed herein. In some examples, aspects of the operations of 1910 may be performed by a context manager 1330 as described with reference to FIG. 13.

At 1915, the method may include receiving, from the CU, a UE context setup request message indicating remote UE bearer information associated with the second UE, the remote UE bearer information including a remote UE identifier, one or more bearer identifiers, mapping of a radio link control channel between the first UE and the DU, uplink user plane tunneling information, or any combination thereof for the second UE. The operations of 1915 may be performed in accordance with examples as disclosed herein. In some examples, aspects of the operations of 1915 may be performed by a context manager 1330 as described with reference to FIG. 13.

At 1920, the method may include establishing, at an adaptation layer of the DU, a relaying configuration for the second UE connecting to the network entity via the first UE, the relaying configuration including multiplexing and forwarding information for a connection between the first UE and the DU. The operations of 1920 may be performed in accordance with examples as disclosed herein. In some examples, aspects of the operations of 1920 may be performed by a relaying configuration manager 1335 as described with reference to FIG. 13.

At 1925, the method may include communicating with the second UE via the first UE according to the UE context information and the relaying configuration. The operations of 1925 may be performed in accordance with examples as disclosed herein. In some examples, aspects of the operations of 1925 may be performed by a relay manager 1340 as described with reference to FIG. 13.

The following provides an overview of aspects of the present disclosure:

Aspect 1: A method for wireless communication at a CU of a network entity, comprising: receiving, from a first UE via a second UE, a connection setup request message for a first UE; establishing UE context information for the first UE at an adaptation layer of the CU, the UE context information based at least in part on communications between the first UE and the network entity via the second UE; transmitting, to one or more DUs associated with the CU, an indication of a relaying configuration for the first UE connecting to the network entity via the second UE, the relaying configuration comprising multiplexing and forwarding information for a connection between the second UE and each DU of the one or more DUs; and communicating with the first UE via the second UE according to the UE context information and the relaying configuration.

Aspect 2: The method of aspect 1, wherein establishing the UE context information for the first UE comprises: allocating, at a control plane of the CU, a remote UE identifier to the first UE; establishing association and context information for the first UE and the second UE, the association and context information comprising an association between the remote UE identifier and the first UE, one or more bearers for the first UE, or both; establishing multiplexing information for the one or more bearers of the first UE, the multiplexing information comprising a first mapping between the one or more bearers of the first UE to one or more sidelink channels between the first UE and the second UE and a second mapping between the sidelink channel to one or more cellular channels of the second UE; and assigning, based at least in part on the multiplexing information, channel identifiers to the one or more sidelink channels and to the one or more cellular channels.

Aspect 3: The method of aspect 2, further comprising: transmitting the indication of the context information to the first UE and to the second UE.

Aspect 4: The method of any of aspects 2 through 3, further comprising: determining an end-to-end quality of service for the one or more bearers of the first UE; and establishing a sidelink quality of service parameter for each of the one or more sidelink channels and the one or more cellular channels based at least in part on the end-to-end quality of service.

Aspect 5: The method of any of aspects 2 through 4, further comprising: determining a slicing configuration for the one or more bearers of the first UE, wherein the relaying configuration is based at least in part on the slicing configuration.

Aspect 6: The method of any of aspects 2 through 5, further comprising: determining, at the control plane of the CU, at a user plane of the CU, or both, an adaptation layer PDU mapping for the first UE, the PDU mapping comprising a PDU-to-PDCP mapping of the first UE, a PDU-to-channel mapping for the one or more cellular channels, or both.

Aspect 7: The method of any of aspects 1 through 6, further comprising: transmitting, from a control plane of the CU to a user plane of the CU, an indication of a remote UE identifier for the first UE; and transmitting, to the one or more DUs, an indication of one or more relay cellular channels associated with the first UE.

Aspect 8: The method of any of aspects 1 through 7, further comprising: transmitting, from a control plane of the CU to a user plane of the CU, a bearer context message for the first UE indicating uplink user plane tunneling information mapping a radio link control channel between the second UE and the DU to a bearer associated with the first UE, wherein the mapping is based at least in part on a local remote UE identifier associated with the first UE.

Aspect 9: The method of any of aspects 1 through 8, further comprising: transmitting, from a control plane of the CU to a user plane of the CU, a bearer context message for the first UE indicating downlink user plane tunneling information mapping a radio link control channel between the second UE and the DU to a bearer associated with the first UE.

Aspect 10: A method for wireless communication at a DU of a network entity, comprising: receiving, from a CU of the network entity, an indication of a relaying configuration for a first UE connecting to the network entity via a second UE; determining, based at least in part on the relaying configuration, multiplexing and forwarding information for the connection between the second UE and the DU; and relaying communications between the first UE and the network entity via the second UE according to the multiplexing and forwarding information.

Aspect 11: The method of aspect 10, further comprising: receiving, from the CU of the network entity, an indication of a relay channel configuration associated with the first UE; and establishing one or more relay cellular channels with the second UE based at least in part on the relay channel configuration.

Aspect 12: A method for wireless communication at a DU of a network entity, comprising: obtaining, from a CU of the network entity, a context setup request message for a first UE; establishing UE context information for the first UE at the CU, the UE context information based at least in part on communications between a second UE and the network entity via the first UE; establishing, at an adaptation layer of the DU, a relaying configuration for the second UE connecting to the network entity via the first UE, the relaying configuration comprising multiplexing and forwarding information for a connection between the first UE and the DU; and communicating with the second UE via the first UE according to the UE context information and the relaying configuration.

Aspect 13: The method of aspect 12, further comprising: receiving, from the CU, a UE context setup request message indicating remote UE bearer information associated with the second UE, the remote UE bearer information comprising a remote UE identifier, one or more bearer identifiers, mapping of a radio link control channel between the first UE and the DU, uplink user plane tunneling information, or any combination thereof for the second UE.

Aspect 14: The method of any of aspects 12 through 13, further comprising: transmitting, to the CU, a UE context setup response message indicating a result of establishing remote UE bearers associated with the first UE, the UE context setup response message comprising at least one of a remote UE identifier, one or more bearer identifiers, downlink user plane tunneling information, or any combination thereof for the first UE.

Aspect 15: The method of any of aspects 12 through 14, further comprising: establishing association and context information for the first UE and the second UE, the association and context information comprising an association between a remote UE identifier and the first UE, one or more bearers for the first UE, or both; establishing multiplexing information for the one or more bearers of the first UE, the multiplexing information comprising a first mapping between the one or more bearers of the first UE to one or more sidelink channels between the first UE and the second UE and a second mapping between the sidelink channel to one or more cellular channels of the second UE; and assigning, based at least in part on the multiplexing information, channel identifiers to the one or more sidelink channels and to the one or more cellular channels.

Aspect 16: The method of any of aspects 12 through 15, further comprising: receiving, from a control plane of the CU, an indication of downlink traffic for the first UE, the indication comprising a remote UE identifier associated with the first UE, a remote UE bearer identifier, a relay cellular channel identifier, or any combination thereof; and transmitting the downlink traffic to the first UE for forwarding to the second UE according to the indication.

Aspect 17: The method of any of aspects 12 through 16, further comprising: receiving, from the first UE, an indication of uplink traffic from the second UE, the indication comprising a remote UE identifier associated with the first UE, a remote UE bearer identifier, a relay cellular channel identifier, or any combination thereof; and transmitting the uplink traffic to a control plane of the UE for forwarding to a destination address associated with the uplink traffic.

Aspect 18: The method of any of aspects 12 through 17, wherein SRBs and DRBs are managed at the DU of the network entity or the SRBs are managed at the CU of the network entity with the DRBs being managed at the DU of the network entity.

Aspect 19: An apparatus for wireless communication at a CU of a network entity, comprising a processor; memory coupled with the processor; and instructions stored in the memory and executable by the processor to cause the apparatus to perform a method of any of aspects 1 through 9.

Aspect 20: An apparatus for wireless communication at a CU of a network entity, comprising at least one means for performing a method of any of aspects 1 through 9.

Aspect 21: A non-transitory computer-readable medium storing code for wireless communication at a CU of a network entity, the code comprising instructions executable by a processor to perform a method of any of aspects 1 through 9.

Aspect 22: An apparatus for wireless communication at a DU of a network entity, comprising a processor; memory coupled with the processor; and instructions stored in the memory and executable by the processor to cause the apparatus to perform a method of any of aspects 10 through 11.

Aspect 23: An apparatus for wireless communication at a DU of a network entity, comprising at least one means for performing a method of any of aspects 10 through 11.

Aspect 24: A non-transitory computer-readable medium storing code for wireless communication at a DU of a network entity, the code comprising instructions executable by a processor to perform a method of any of aspects 10 through 11.

Aspect 25: An apparatus for wireless communication at a DU of a network entity, comprising a processor; memory coupled with the processor; and instructions stored in the memory and executable by the processor to cause the apparatus to perform a method of any of aspects 12 through 18.

Aspect 26: An apparatus for wireless communication at a DU of a network entity, comprising at least one means for performing a method of any of aspects 12 through 18.

Aspect 27: A non-transitory computer-readable medium storing code for wireless communication at a DU of a network entity, the code comprising instructions executable by a processor to perform a method of any of aspects 12 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a central unit (CU) of a network entity, comprising:
a processor;
memory coupled with the processor; and
instructions stored in the memory and executable by the processor to cause the apparatus to:
receive, from a first user equipment (UE) via a second UE, a connection setup request message for a first UE;
establish UE context information for the first UE at an adaptation layer of the CU, the UE context information based at least in part on communications between the first UE and the network entity via the second UE;
transmit, to one or more distributed units (DUs) associated with the CU, an indication of a relaying configuration for the first UE connecting to the network entity via the second UE, the relaying configuration comprising multiplexing and forwarding information for a connection between the second UE and each DU of the one or more DUs; and
communicate with the first UE via the second UE according to the UE context information and the relaying configuration.

2. The apparatus of claim 1, wherein the instructions to establish the UE context information for the first UE are executable by the processor to cause the apparatus to:
allocate, at a control plane of the CU, a remote UE identifier to the first UE;
establish association and context information for the first UE and the second UE, the association and context information comprising an association between the remote UE identifier and the first UE, one or more bearers for the first UE, or both;
establish multiplexing information for the one or more bearers of the first UE, the multiplexing information comprising a first mapping between the one or more bearers of the first UE to one or more sidelink channels between the first UE and the second UE and a second mapping between the sidelink channel to one or more cellular channels of the second UE; and
assign, based at least in part on the multiplexing information, channel identifiers to the one or more sidelink channels and to the one or more cellular channels.

3. The apparatus of claim 2, wherein the instructions are further executable by the processor to cause the apparatus to:
transmit the indication of the context information to the first UE and to the second UE.

4. The apparatus of claim 2, wherein the instructions are further executable by the processor to cause the apparatus to:
determine an end-to-end quality of service for the one or more bearers of the first UE; and
establish a sidelink quality of service parameter for each of the one or more sidelink channels and the one or more cellular channels based at least in part on the end-to-end quality of service.

5. The apparatus of claim 2, wherein the instructions are further executable by the processor to cause the apparatus to:
determine a slicing configuration for the one or more bearers of the first UE, wherein the relaying configuration is based at least in part on the slicing configuration.

6. The apparatus of claim 2, wherein the instructions are further executable by the processor to cause the apparatus to:
determine, at the control plane of the CU, at a user plane of the CU, or both, an adaptation layer protocol data unit (PDU) mapping for the first UE, the PDU mapping comprising a PDU-to-packet data convergence protocol (PDCP) mapping of the first UE, a PDU-to-channel mapping for the one or more cellular channels, or both.

7. The apparatus of claim 1, wherein the instructions are further executable by the processor to cause the apparatus to:
transmit, from a control plane of the CU to a user plane of the CU, an indication of a remote UE identifier for the first UE; and
transmit, to the one or more DUs, an indication of one or more relay cellular channels associated with the first UE.

8. The apparatus of claim 1, wherein the instructions are further executable by the processor to cause the apparatus to:
transmit, from a control plane of the CU to a user plane of the CU, a bearer context message for the first UE indicating uplink user plane tunneling information mapping a radio link control channel between the second UE and the DU to a bearer associated with the first UE, wherein the mapping is based at least in part on a local remote UE identifier associated with the first UE.

9. The apparatus of claim 1, wherein the instructions are further executable by the processor to cause the apparatus to:
transmit, from a control plane of the CU to a user plane of the CU, a bearer context message for the first UE indicating downlink user plane tunneling information mapping a radio link control channel between the second UE and the DU to a bearer associated with the first UE.

10. An apparatus for wireless communication at a distributed unit (DU) of a network entity, comprising:
a processor;
memory coupled with the processor; and
instructions stored in the memory and executable by the processor to cause the apparatus to:
receive, from a central unit (CU) of the network entity, an indication of a relaying configuration for a first user equipment (UE) connecting to the network entity via a second UE;
determine, based at least in part on the relaying configuration, multiplexing and forwarding information for the connection between the second UE and the DU; and
relay communications between the first UE and the network entity via the second UE according to the multiplexing and forwarding information.

11. The apparatus of claim 10, wherein the instructions are further executable by the processor to cause the apparatus to:
receive, from the CU of the network entity, an indication of a relay channel configuration associated with the first UE; and
establish one or more relay cellular channels with the second UE based at least in part on the relay channel configuration.

12. An apparatus for wireless communication at a distributed unit (DU) of a network entity, comprising:
a processor;
memory coupled with the processor; and
instructions stored in the memory and executable by the processor to cause the apparatus to:
obtain, from a central unit (CU) of the network entity, a context setup request message for a first user equipment (UE);
establish UE context information for the first UE at the CU, the UE context information based at least in part on communications between a second UE and the network entity via the first UE;
establish, at an adaptation layer of the DU, a relaying configuration for the second UE connecting to the network entity via the first UE, the relaying configuration comprising multiplexing and forwarding information for a connection between the first UE and the DU; and
communicate with the second UE via the first UE according to the UE context information and the relaying configuration.

13. The apparatus of claim 12, wherein the instructions are further executable by the processor to cause the apparatus to:
receive, from the CU, a UE context setup request message indicating remote UE bearer information associated with the second UE, the remote UE bearer information comprising a remote UE identifier, one or more bearer identifiers, mapping of a radio link control channel between the first UE and the DU, uplink user plane tunneling information, or any combination thereof for the second UE.

14. The apparatus of claim 12, wherein the instructions are further executable by the processor to cause the apparatus to:
transmit, to the CU, a UE context setup response message indicating a result of establishing remote UE bearers associated with the first UE, the UE context setup response message comprising at least one of a remote UE identifier, one or more bearer identifiers, downlink user plane tunneling information, or any combination thereof for the first UE.

15. The apparatus of claim 12, wherein the instructions are further executable by the processor to cause the apparatus to:
establish association and context information for the first UE and the second UE, the association and context information comprising an association between a remote UE identifier and the first UE, one or more bearers for the first UE, or both;
establish multiplexing information for the one or more bearers of the first UE, the multiplexing information comprising a first mapping between the one or more bearers of the first UE to one or more sidelink channels between the first UE and the second UE and a second mapping between the sidelink channel to one or more cellular channels of the second UE; and
assign, based at least in part on the multiplexing information, channel identifiers to the one or more sidelink channels and to the one or more cellular channels.

16. The apparatus of claim 12, wherein the instructions are further executable by the processor to cause the apparatus to:
receive, from a control plane of the CU, an indication of downlink traffic for the first UE, the indication comprising a remote UE identifier associated with the first UE, a remote UE bearer identifier, a relay cellular channel identifier, or any combination thereof; and
transmit the downlink traffic to the first UE for forwarding to the second UE according to the indication.

17. The apparatus of claim 12, wherein the instructions are further executable by the processor to cause the apparatus to:
receive, from the first UE, an indication of uplink traffic from the second UE, the indication comprising a remote UE identifier associated with the first UE, a remote UE bearer identifier, a relay cellular channel identifier, or any combination thereof; and
transmit the uplink traffic to a control plane of the UE for forwarding to a destination address associated with the uplink traffic.

18. A method for wireless communication at a central unit (CU) of a network entity, comprising:
receiving, from a first user equipment (UE) via a second UE, a connection setup request message for a first UE;
establishing UE context information for the first UE at an adaptation layer of the CU, the UE context information based at least in part on communications between the first UE and the network entity via the second UE;
transmitting, to one or more distributed units (DUs) associated with the CU, an indication of a relaying configuration for the first UE connecting to the network entity via the second UE, the relaying configuration comprising multiplexing and forwarding information for a connection between the second UE and each DU of the one or more DUs; and
communicating with the first UE via the second UE according to the UE context information and the relaying configuration.

19. The method of claim 18, wherein establishing the UE context information for the first UE comprises:
allocating, at a control plane of the CU, a remote UE identifier to the first UE;
establishing association and context information for the first UE and the second UE, the association and context information comprising an association between the remote UE identifier and the first UE, one or more bearers for the first UE, or both;
establishing multiplexing information for the one or more bearers of the first UE, the multiplexing information comprising a first mapping between the one or more bearers of the first UE to one or more sidelink channels between the first UE and the second UE and a second mapping between the sidelink channel to one or more cellular channels of the second UE; and
assigning, based at least in part on the multiplexing information, channel identifiers to the one or more sidelink channels and to the one or more cellular channels.

20. The method of claim 19, further comprising:
transmitting the indication of the context information to the first UE and to the second UE.

21. The method of claim 19, further comprising:
determining an end-to-end quality of service for the one or more bearers of the first UE; and
establishing a sidelink quality of service parameter for each of the one or more sidelink channels and the one or more cellular channels based at least in part on the end-to-end quality of service.

22. The method of claim 19, further comprising:
determining a slicing configuration for the one or more bearers of the first UE, wherein the relaying configuration is based at least in part on the slicing configuration.

23. The method of claim 19, further comprising:
determining, at the control plane of the CU, at a user plane of the CU, or both, an adaptation layer protocol data unit (PDU) mapping for the first UE, the PDU mapping comprising a PDU-to-packet data convergence protocol (PDCP) mapping of the first UE, a PDU-to-channel mapping for the one or more cellular channels, or both.

24. The method of claim 18, further comprising:
transmitting, from a control plane of the CU to a user plane of the CU, an indication of a remote UE identifier for the first UE; and
transmitting, to the one or more DUs, an indication of one or more relay cellular channels associated with the first UE.

25. The method of claim 18, further comprising:
transmitting, from a control plane of the CU to a user plane of the CU, a bearer context message for the first UE indicating uplink user plane tunneling information mapping a radio link control channel between the second UE and the DU to a bearer associated with the first UE, wherein the mapping is based at least in part on a local remote UE identifier associated with the first UE.

26. The method of claim 18. further comprising:
transmitting. from a control plane of the CU to a user plane of the CU. a bearer context message for the first UE indicating downlink user plane tunneling information mapping a radio link control channel between the second UE and the DU to a bearer associated with the first UE.
